(19) United States
(12) Patent Application Publication
(10) Pub. No.: US 2011/0258529 A1
(43) Pub. Date: Oct. 20, 2011

(54) SYSTEMS AND METHODS FOR EXCLUDING SERVING AN ADVERTISEMENT CAMPAIGN TO UNDESIRED WEB PAGES

(76) Inventors: Toby Doig, Herts (GB); Craig Allen Gooding, London (GB)

(21) Appl. No.: 12/762,125

(22) Filed: Apr. 16, 2010

(51) Int. Cl. G06F 21/00; G06F 17/00

(52) U.S. Cl. 715/234; 726/22

(57) ABSTRACT

Systems and methods are presented for determining whether a web page loaded by a user from a server other than the server of the enterprise providing the advertisement content is safe for displaying the advertisement content. In some aspects, the systems and methods discussed determine if content of a web page to be augmented is content safe for delivering content from a publisher. A script of a web page being loaded by a browser which may execute on a client may identify that content from a publisher is to be displayed with content of the web page. The script may transmit to a server a request to check a safeness of the content of the web page prior to displaying the publisher's content. The script may receive from the server, responsive to the server determining the content of the web page is not safe for the publisher, a predetermined content not from the publisher to display on the web page.

### FIELD OF THE INVENTION

The disclosure generally relates to the field of data augmentation, in particular to augmenting web pages with advertisement content.

### BACKGROUND

An enterprise may wish to provide advertisement content on web pages served by third party servers to users accessing the web pages via the world wide web. The enterprise may provide the advertisement content in a format which may be included or embedded within web pages. The enterprise may wish to choose which web sites are allowed to include the publisher content. In some instances, the enterprise may request that the advertisement content be displayed within some web pages and not within others. As web pages may be provided by third party servers, the enterprise may wish to control or monitor access of the content advertised on the web pages provided by the third party servers.

### SUMMARY OF THE INVENTION

The present disclosure relates to systems and methods for determining whether a web page loaded by a user from a server other than the server of the enterprise providing the advertisement content is safe for displaying the advertisement content. The systems and methods presented may also be used for determining if a content of a web page loaded by a client's browser is content safe for including and displaying an advertisement content from a publisher. The content from a publisher may be any publisher content, such as for example an advertisement, a commercial, an announcement or a flyer from an enterprise.

In some aspects, the present disclosure relates to systems and methods for determining that content of a web page is content safe for delivering content from a publisher. A script of a web page being loaded by a browser which may execute on a client may identify that content from a publisher is to be displayed with content of the web page. The script may transmit to a server a request to check a safeness of the content of the web page prior to displaying the publisher's content. The script may receive from the server, responsive to the server determining the content of the web page is not safe for the publisher, a predetermined content not from the publisher to display on the web page.

In some embodiments, the browser displays the predetermined content instead of the content from the publisher. In some embodiments, the script identifies a publisher identifier for the content. In some embodiments, the script identifies a campaign identifier of the publisher. In further embodiments, the script transmits with the request one of a publisher identifier or a campaign identifier to the server. In further embodiments, the script transmits with the request a uniform resource locator of the web page. In still further embodiments, the script receives from the server the predetermined content comprising blank content. In yet further embodiments, the script receives from the server the predetermined content comprising a predetermined advertisement not from the publisher. In still further embodiments, the script modifies the keyword to include a hyperlink identifying a uniform resource locator to the predetermined content. In yet further embodiments, the browser executes the script upon loading of the web page by the browser. In still further embodiments, the browser receives the content from the publisher together with the script while the browser loads the web page.

In some aspects, the present disclosure relates to a method for determining that content of a web page is content safe for delivering content from a publisher. A server may receive from a browser of a client a request to check a safeness of content of a web page being loaded by the browser. The content of the web page may have a content of a publisher to be displayed. The server may obtain for the publisher a list of exclusion uniform resource locators for which to exclude displaying the content of the publisher. The server may determine whether a uniform resource locator of the web page matches an exclusion uniform resource locator in the list of exclusion uniform resources locators for the publisher.

In some embodiments, the server receives with the request a publisher identifier and a campaign identifier of the publisher. In further embodiments, the server receives with the request the one or more resource locators of the web page. In still further embodiments, the server selects for the publisher the list of exclusion uniform resource locators based on a campaign identifier of the publisher. In yet further embodiments, the server determines that the uniform resource locator of the web page matches the exclusion uniform resource locator in the list of exclusion uniform resources locators. In still further embodiments, the server determines that a second uniform resource locator linked via the web page matches the exclusion uniform resource locator in the list of exclusion uniform resources locators. In yet further embodiments, the server transmits to the browser a predetermined content not from the publisher to be displayed on the web page responsive to determining that the uniform resource locator of the web page matches a in the list of exclusion uniform resources locators for the publisher. In still further embodiments, the server transmits to the browser content of the publisher to augment to display on the web page in response to determining that the uniform resource locator of the web page does not match any entries in the list of exclusion uniform resources locators for the publisher. In still further embodiments, the server obtains a list of exclusion keywords identifying portions of the uniform resource locator of the web page for which to exclude displaying the content of the publisher. In yet further embodiments, the server determines whether a portion of the uniform resource locator of the web page matches an exclusion keyword in the list of exclusion keywords. In yet further embodiments, the server transmits a predetermined content not from the publisher to display on the web page in response to determining that the portion of the uniform resource locator matches the exclusion keyword in the list of exclusion keywords.

In some aspects, the present disclosure relates to a method for determining that content of a web page on which additional content is to be displayed is content safe for delivering the additional content from an advertisement network. A script of a browser executing on a client may identify upon loading a web page that the web page is to be augmented with content from an advertisement network. The script may transmit to a server a request to check a safeness of content of the web page prior to augmenting the web page with the content from the advertisement network. The script may receive from the server responsive to the server determining the content of the web page is not safe, a predetermined content not from the advertisement network to be displayed instead of the content from the advertisement network.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The foregoing and other objects, aspects, features, and advantages of the present invention will become more apparent and better understood by referring to the following description taken in conjunction with the accompanying drawings, in which:

FIG. 1A is a block diagram that depicts an embodiment of an environment for providing systems and methods described herein.

FIGS. 1B and 1C are block diagrams of computing devices that may be used in any of the embodiments of the systems and methods described herein

FIG. 2 is a block diagram that depicts an embodiment of an augmentation server in FIG. 1.

FIG. 3A is a flow diagram of an embodiment of a method of producing augmented content.

FIG. 3B is a flow diagram of an embodiment of a method of providing augmented content to users.

FIG. 3C is a flow diagram of an embodiment of a process of operation of advertisement and client code.

FIGS. 4A through 4E are screenshots illustrating a web page, its corresponding augmented web page, and a viewer's user experience interacting with the augmented web page according to one embodiment of the present disclosure.

FIG. 5A is block diagram of an embodiment of an ad server platform and platform services.

FIG. 5B is a diagram of an embodiment of stages of a request from a client for platform services.

FIG. 5C is a diagram of an embodiment of contextual targeting.

FIG. 5D is a diagram of another embodiment of contextual targeting.

FIG. 5E is a diagram of an embodiment of contextual and behavioral targeting.

FIG. 5F is a diagram of another embodiment of contextual and behavioral targeting.

FIG. 5G is a diagram of another embodiment of contextual and behavioral targeting.

FIG. 5H is a diagram of an embodiment of campaign selection engine.

FIG. 5I is block diagram of an embodiment of a system to provide augmented content for a keyword on a web page.

FIG. 5J is a diagrammatic view of an embodiment of augmented content.

FIG. 5K is a flow diagram of an embodiment of a method for delivering augmented content for a keyword on a web page.

FIG. 6A is a block diagram of an embodiment of a system for determining safeness of a web page for displaying content from a publisher.

FIG. 6B is a flow diagram of an embodiment of steps for determining whether a web page provided by a third party server is safe for displaying content from a publisher.

FIG. 6C is a flow chart of an embodiment of steps for determining safeness of a web page based on the contents and the uniform resource locator of the web page.

FIG. 6D is block diagram of an embodiment of a database storing information used for determining safeness of web pages for displaying content from a publisher.

FIG. 6E is a flow chart of an embodiment of steps for determining safeness of a web page based on the URL and the contents of the web page and the third party contents.

FIG. 6F is block diagram of another embodiment of a database storing information used for determining safeness of web pages for displaying content from a publisher.

In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a network and computing environment which may be useful for practicing embodiments described herein;
Section B describes embodiments of systems and methods for delivering a augmented content;
Section C describes embodiments of systems and methods of an ad server platform for delivering a plurality of advertisement and augmented content services; and
Section D describes embodiments of systems and methods of determining safeness for displaying content of a publisher or advertiser.

A. System and Network Environment

Some of the disclosed embodiments describe examples of a method (and corresponding system and computer program product) for augmenting files with related resources through layered augmentation. Viewers of the augmented files can access the related resources through a multi-layered dialog box. The process of providing additional resources through multilayered dialog box and the multi-layered dialog box are collectively called layered augmentation.

An embodiment of the method identifies data in a file, associates the identified data with reference data in a reference database, and stores the associations in a corresponding augmented file. A viewer of the augmented file can access resources related to a piece of augmented data through layered augmentation. When the viewer moves a pointer over the piece of augmented data (also called mouse-over), the related resources are provided in a multi-layered dialog box. The dialog box is overlaid on the augmented file approximate to the position where the mouse-over occurred. The viewer can navigate through the related resources in the dialog box without leaving the augmented file.

As described herein, a file includes any types of documents such as web pages. Augmented data, the data with integrated association in an augmented file, include any types of content such as text and image. Resources provided through layered augmentations include textual content, visual content such as images and videos, interactive controls such as dialog boxes, and services such as Internet search service and advertisement. A pointer can be any pointer device such as a mouse, a trackball, a roller, and a touchpad. For purposes of illustration, the method (and corresponding system and computer program product) is described in terms of augmenting keywords (or key phrases) in web pages and delivering related advertisements through multi-layered dialog boxes based on user interactions with the augmented keywords, even though the disclosed embodiments apply to all other types of content, files, and resources as defined above.

The figures and the following description relate to preferred embodiments by way of illustration only. Reference will now be made in detail to several embodiments, examples of which are illustrated in the accompanying figures. The figures depict embodiments of the disclosed system (or method) for purposes of illustration only. It should be noted that from the following discussion, other or alternate embodiments of the structures and methods disclosed herein will be readily recognized by one skilled in the art as viable alternatives that may be employed without departing from the principles described herein.

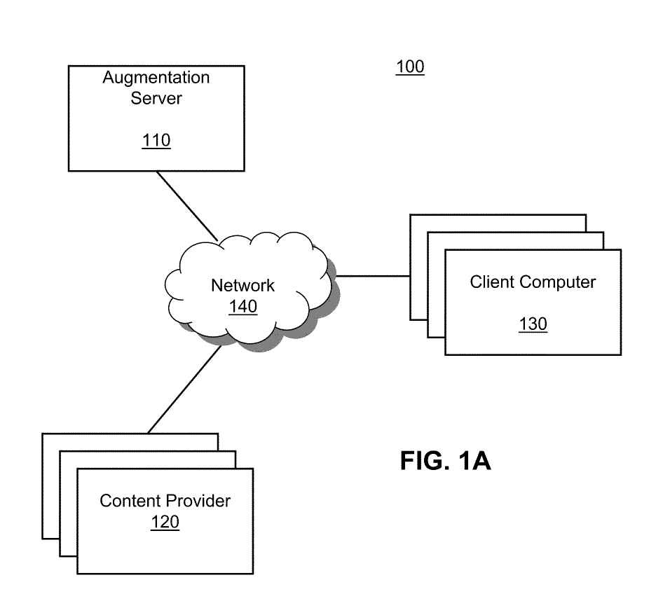

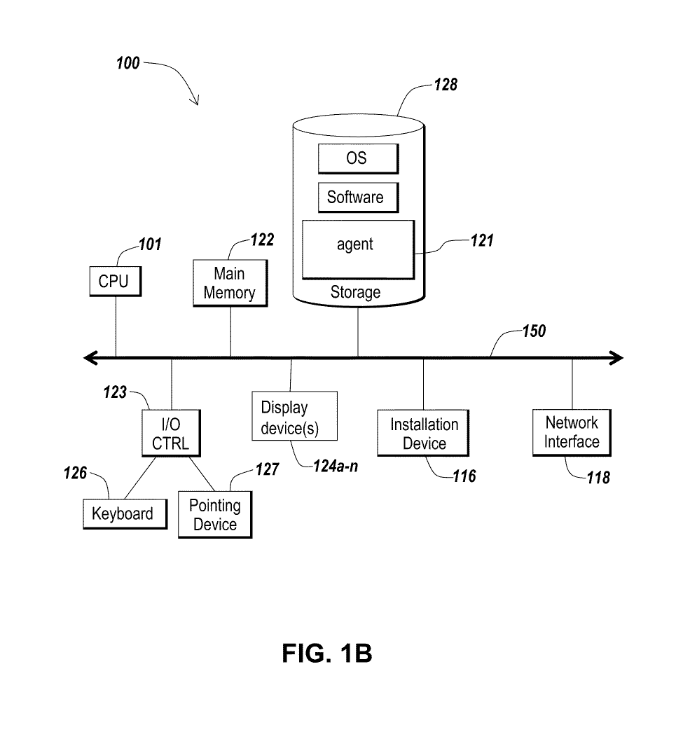

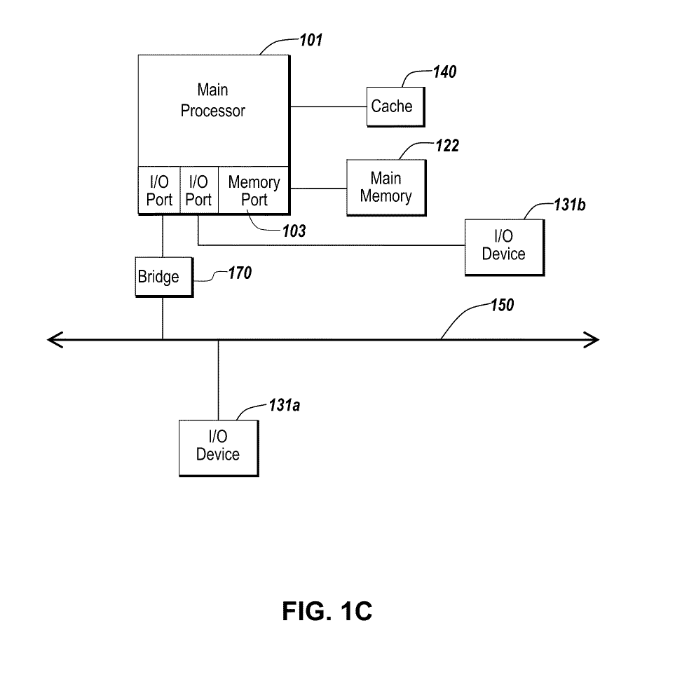

FIG. 1A illustrates an embodiment of a computing environment 100 for augmenting web pages and providing viewers of the augmented web pages with related advertisements through layered augmentation based on user interaction. As illustrated, the computing environment 100 includes an augmentation server 110, multiple content providers (or websites) 120, and one or more client computers (or user systems) 130, all of which are communicatively coupled through a network 140.

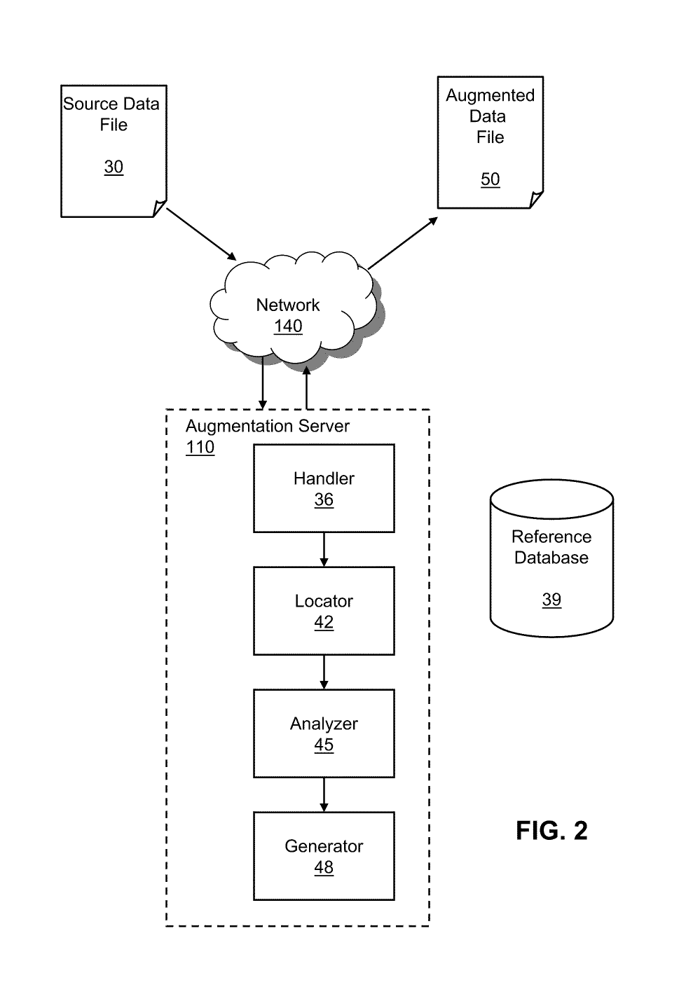

The augmentation server 110 is configured to augment keywords (or other types of content) in web pages (or other types of documents) with advertisements (or other types of resources), and deliver the advertisements based on user interaction with the augmented keywords. The augmentation server 110 retrieves web pages from the content providers 120 and augments the web pages. The augmentation server 110 augments a web page by identifying keywords in the web page, associating (or tagging) the keywords with one or more related references in a reference database, generating an augmented web page, and storing the associations in a database. When a user views an augmented web page in a client computer 130 and moves a pointer over one of the augmented keywords (hereinafter “the activated keyword”), the augmentation server 110 displays (or avails) related advertisements in the client computer 130 through a multi-layered dialog box. An example architecture of the augmentation server 110 is described in detail below with respect to FIG. 2.

The content providers 120 are entities that provide (or generate), host, publish, control, or otherwise have rights over a collection of web pages (or other types of documents). In one embodiment, the content providers 120 are web servers hosting web pages for viewers to access. The content providers 120 may provide web pages to the augmentation server 110 for layered augmentation. Alternatively, the content providers 120 may either instruct or give permission to the augmentation server 110 to retrieve all or parts of their web pages for layered augmentation.

A client 130 may comprise any personal computer (e.g., based on a microprocessor from the x86 family, the Pentium family, the 680x0 family, PowerPC, PA-RISC, MIPS families, the ARM family, the Cell family), network computer, wireless device (e.g. mobile computer, PDA, smartphone), information appliance, workstation, minicomputer, mainframe computer, telecommunications or media device that is capable of communication and that has sufficient processor power and memory capacity to perform the operations described herein. For example, the client 130 may comprise a device of the IPOD family of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED, NINTENDO REVOLUTION, or NINTENDO WII device manufactured by Nintendo Co., Ltd., of Kyoto, Japan, or an XBOX or XBOX 360 device manufactured by the Microsoft Corporation of Redmond, Wash. In some embodiments, the client may include any of the Kindle family of devices sold or provided by Amazon.com.

Operating systems supported by the client 130 can include any member of the WINDOWS family of operating systems from Microsoft Corporation of Redmond, Wash., MacOS, JavaOS, various varieties of Unix (e.g., Solaris, SunOS, Linux, HP-UX, A/IX, and BSD-based distributions), any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, WINDOWS XP, and WINDOWS VISTA, all of which are manufactured by Microsoft Corporation of Redmond, Wash.; MaC OSX, manufactured by Apple Computer of Cupertino, Calif.; OS/2, manufactured by International Business Machines of Armonk, N.Y.; and Linux, an open source operating system distributed by, among others, Red Hat, Inc., or any type and/or form of a Unix operating system, among others.

The client computers 130 may be any type and form of client devices for users to browse web pages (or other types of documents). In one embodiment, a client computer 130 includes a pointer device (e.g., a mouse, a trackball, a roller, a touchpad, or the like), a conventional web browser (e.g., Microsoft Internet Explorer™, Mozilla Firefox™, or Apple Safari™), and can retrieve and display web pages from the content providers 120 in a conventional manner (e.g., using the HyperText Transfer Protocol). In one embodiment, the client computer 130 displays augmented keywords in an augmented web page differently than the non-augmented content. For example, the augmented keywords can be displayed in a double underline style and/or in a color distinctive from texts that are not augmented. When a user moves a pointer (e.g., mouse pointer) over (e.g., mouse-over) an augmented keyword in the augmented web page, the client computer 130 (or the utilized web browser) generates a request and transmits the request to the augmentation server 110. The augmentation server 110 receives the request and determines relevant advertisements to transmit to the client computer 130. The client computer 130 (or the utilized web browser) displays the advertisements retrieved from the augmentation server 110 in a multi-layered dialog box overlaying the augmented web page and proximate to the location where the mouse-over occurred. The multi-layered dialog box displays an advertisement and multiple clickable tabs representing the other retrieved advertisements. The viewer can select (e.g., click) a tab to request the dialog box to display the corresponding advertisement. The viewer may navigate among the multiple advertisements and interact with the advertisements without leaving the augmented web page.

The network 140 is configured to communicatively connect the augmentation server 110, the content providers 120, and the client computers 130. The network 140 may be a wired or wireless network. Examples of the network 140 include the Internet, an intranet, a WiFi network, a WiMAX network, a mobile telephone network, or a combination thereof. The network 140 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 140 may comprise a wireless link, such as an infrared channel or satellite band. The topology of the network 140 may be a bus, star, or ring network topology. The network 140 and network topology may be of any such network or network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In one embodiment, the augmentation server 110, the content providers 120, and/or the client computers 130 are structured to include a processor, memory, storage, network interfaces, and applicable operating system and other functional software (e.g., network drivers, communication protocols). The client 120, server 110, and content providers 120 may be deployed as and/or executed on any type and form of computing device, such as a computer, network device or appliance capable of communicating on any type and form of network and performing the operations described herein.

FIGS. 1B and 1C depict block diagrams of a computing device 100 useful for practicing an embodiment of the client 130, server 110 or content provider 120. As shown in FIGS. 1B and 1C, each computing device 100 includes a central processing unit 101, and a main memory unit 122. As shown in FIG. 1B, a computing device 100 may include a visual display device 124, a keyboard 126 and/or a pointing device 127, such as a mouse. Each computing device 100 may also include additional optional elements, such as one or more input/output devices 131a-131b (generally referred to using reference numeral 131), and a cache memory 140 in communication with the central processing unit 101.

The central processing unit 101 is any logic circuitry that responds to and processes instructions fetched from the main memory unit 122. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 101, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 101 communicates with main memory 122 via a system bus 150 (described in more detail below). FIG. 1C depicts an embodiment of a computing device 100 in which the processor communicates directly with main memory 122 via a memory port 103. For example, in FIG. 1B the main memory 122 may be DRAM.

FIG. 1C depicts an embodiment in which the main processor 101 communicates directly with cache memory 140 via a secondary bus, sometimes referred to as a backside bus. In other embodiments, the main processor 101 communicates with cache memory 140 using the system bus 150. Cache memory 140 typically has a faster response time than main memory 122 and is typically provided by SRAM, BSRAM, or EDRAM. In the embodiment shown in FIG. 1C, the processor 101 communicates with various I/O devices 131 via a local system bus 150. Various busses may be used to connect the central processing unit 101 to any of the I/O devices 131, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 101 may use an Advanced Graphics Port (AGP) to communicate with the display 124. FIG. 1C depicts an embodiment of a computer 100 in which the main processor 101 communicates directly with I/O device 131b via HyperTransport, Rapid I/O, or InfiniBand. FIG. 1C also depicts an embodiment in which local busses and direct communication are mixed: the processor 101 communicates with I/O device 131b using a local interconnect bus while communicating with I/O device 131a directly.

The computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs such as any software 121 related to providing an agent, such as a safe agent, as described herein. The computing device 100 may further comprise a storage device 128, such as one or more hard disk drives or redundant arrays of independent disks, for storing an operating system and other related software, and for storing application software programs such as any program related to an agent 121 as described herein. Optionally, any of the installation devices 116 could also be used as the storage device 128. Additionally, the operating system and the software can be run from a bootable medium, for example, a bootable CD, such as KNOPPIX®, a bootable CD for GNU/Linux that is available as a GNU/Linux distribution from knoppix.net.

Furthermore, the computing device 100 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein. A wide variety of I/O devices 131a-131n may be present in the computing device 100. Input devices include keyboards, mice, trackpads, trackballs, microphones, and drawing tablets. Output devices include video displays, speakers, inkjet printers, laser printers, and dye-sublimation printers. The I/O devices 131 may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage 128 and/or an installation medium 116 for the computing device 100. In still other embodiments, the computing device 100 may provide USB connections to receive handheld USB storage devices such as the USB Flash Drive line of devices manufactured by Twintech Industry, Inc. of Los Alamitos, Calif.

In some embodiments, the computing device 100 may comprise or be connected to multiple display devices 124a-124n, which each may be of the same or different type and/or form. As such, any of the I/O devices 131a-131n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 131 may be a bridge 170 between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGs. AugeB and 1C typically operate under the control of operating systems, which control scheduling of tasks and access to system resources. The computing device 100 can be running any operating system such as any of the versions of the Microsoft® Windows operating systems, the different releases of the Unix and Linux operating systems, any version of the Mac OS® for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, and WINDOWS XP, all of which are manufactured by Microsoft Corporation of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

In other embodiments, the computing device 100 may have different processors, operating systems, and input devices consistent with the device. For example, in one embodiment the computer 100 is a Treo 180, 270, 1060, 600 or 650 smart phone manufactured by Palm, Inc. In this embodiment, the Treo smart phone is operated under the control of the PalmOS operating system and includes a stylus input device as well as a five-way navigator device. In some embodiments, the computing device may include any type and form of wireless reading device, such as any Kindle device manufactured by Amazon.com Inc. of Seattle, Wash. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

B. Systems and Methods for Providing Augmented Content

FIG. 2 is a block diagram illustrating one example architecture of the augmentation server 110 as described above with respect to FIG. 1. As illustrated, the augmentation server 110 includes a handler 36, a locator 42, an analyzer 45, a generator 48, and a reference database 39. The components 36 through 45 may include a software or firmware instruction that can be stored within a tangible computer readable medium (e.g., magnetic disk drive, optical disk or solid state memory such as flash memory, or random-access memory) and executed by a processor or equivalent electrical circuits, state machines, microcode, or the like.

A source data file 30 (e.g., a web page) resides on a server (e.g., a content provider 120) on a network 140 (e.g., the Internet). The handler 36 retrieves the source data file 30 for augmentation by the augmentation server 110. The locator 42 examines the retrieved source data file 30 for comparison to data in the reference database 39. In one embodiment, the locator 42 analyzes content of the source data file 30 for keywords, searches corresponding reference data in the reference database 39, and provides the keywords and the corresponding reference data to the analyzer 45. In an alternate embodiment, rather than analyzing the source data file 30 for keywords, the locator 42 retrieves a list of keywords from the reference database 39 and enumerates through the textual content of the source data file 30 for matches.

The analyzer 45 creates associations between the keywords and the corresponding reference data found by the locator 42. The generator 48 generates an augmented data file 50 by embedding the associations created by the analyzer 45 in the source data file 30. The generator 48 embeds associations by generating intelligent tags for the keywords, and augmenting the keywords with the intelligent tags. In one embodiment, an intelligent tag is an alphabetic and/or numeric string that identifies its associated keywords, and/or reference data, and optionally includes an unique identification number (hereinafter called the association ID). The generator 48 inserts the generated intelligent tags into the source data file 30 to generate the augmented data file 50. Web pages with the integrated intelligent tags are called augmented web pages. Keywords with the integrated intelligent tags are called augmented keywords. The generator 48 also stores the identified keywords and/or the associations in a database for later references.

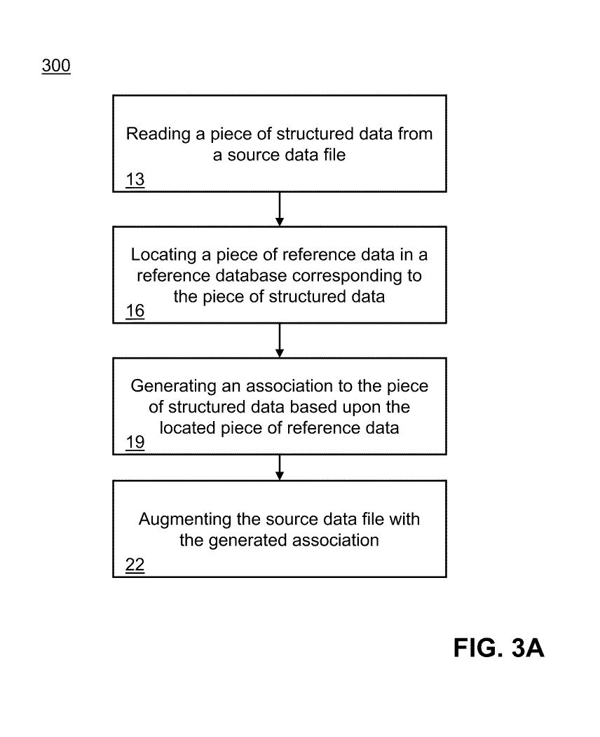

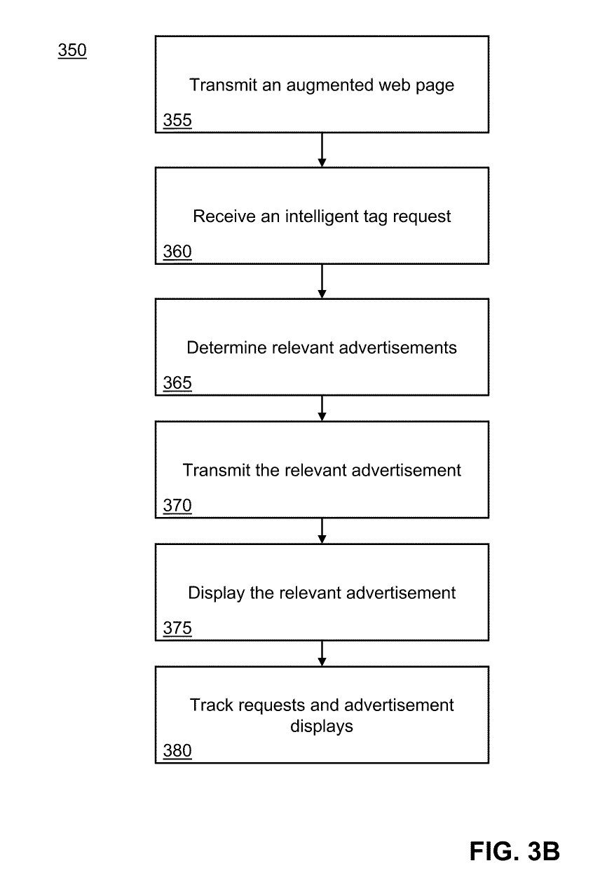

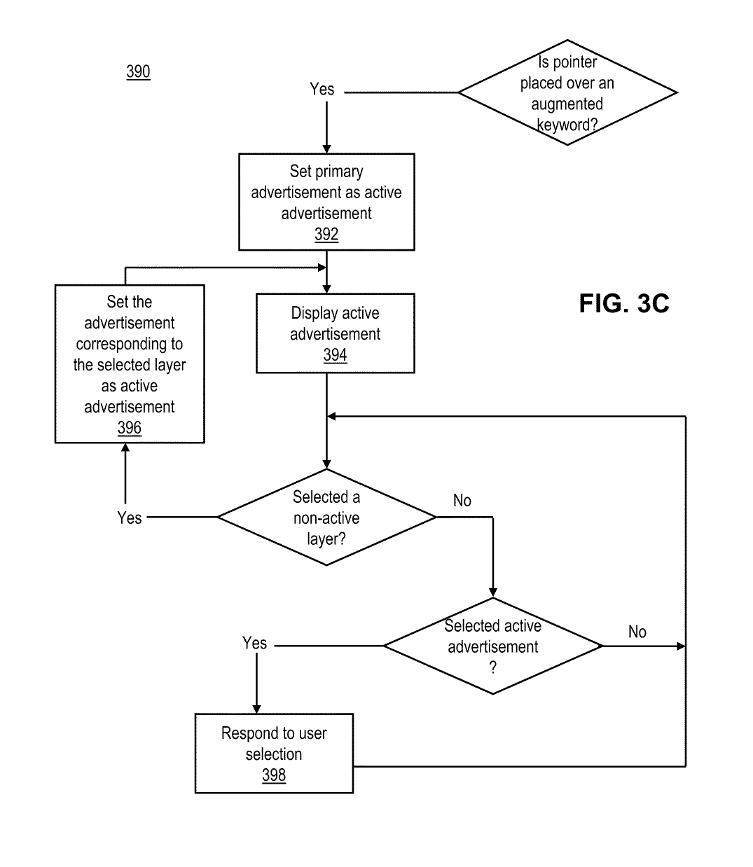

The resulting augmented data file 50 is returned to the handler 36 to reside at a Universal Resource Locator (URL) address on the network 140 (e.g., at the content provider 120 from which the source data file 30 is retrieved). In one embodiment, the handler 36 also receives requests (or signals) from client computers 130 indicating user interactions with the augmented data file, and transmits to the client computers 130 related advertisements for display through layered augmentation. Layered augmentation is described in detail below with respect to FIGS. 3A through 3C. The handler 36 retrieves the activated keywords (e.g., from the requests), and determines one or more relevant advertisements from an advertising database (not shown) that matches the keywords and/or the associated reference data. In one embodiment, rather than transmitting the related advertisements, the handler 36 transmits addresses (e.g., URLs) of the relevant advertisements to the requesting client computer 130. The client computer 130 resolves the addresses to retrieve the advertisements.

The reference database 39 stores reference data such as types of advertisements (e.g., television advertisements), categories of advertisements (e.g., storage rental, home equity loan), and/or information about specific advertisements (e.g., associated keywords, format information, price the advertiser is willing to pay, and URL of the advertisement). The reference database 39 may be a relational database or any other type of database that stores the data, such as a flat file. In one embodiment, the reference database 39 is a web enabled reference database supporting remote calls through the Internet to the reference database 39.

The components of the augmentation server 110 can reside on a single computer system or several computer systems located close by or remotely from each other. For example, the analyzer 45 and the generator 48 may reside on separate web servers, and the reference database 39 may be located in a dedicated database server. In addition, any of the components or sub-components may be executed in one or multiple computer systems.

Web pages (or web browsers) can provide additional information to viewers. For example, when a user places a mouse over a link label of a hyperlink, a web browser displays the associated destination URL (e.g., on a status bar of the web browser). As another example, when a user places a pointer over a keyword, the web browser may generate a pop-up dialog box, and display relevant information (e.g., an explanation of the keyword). The process of providing additional information to web page viewers is called augmentation.

A keyword (or phrase) often has multiple aspects of related information, each having multiple aspects of related information. For example, the key phrase “digital camera” is related to its history, underlying technology, and available products and services. A specific product related to digital camera has related information such as product description, customer review, and competing products. Usually only one aspect of the related information is provided through augmentation due to limited display space.

Multiple aspects of related information can be arranged and provided to viewers through layered augmentation. Each aspect of related information can be assigned to one specific layer of the layered augmentation. Viewers can navigate among the multiple aspects of related information by accessing the different layers of the layered augmentation without leaving the web page. For example, the augmented information can be displayed in a multi-layered dialog box. A viewer can navigate among different layers by selecting associated tabs displayed in the dialog box in which each tab is associated with a layer. Alternatively, the multiple layers may be stacked in a manner similar to windows in Microsoft Windows™ Operating System. The stacked layers may be arranged in a horizontal, vertical, or cascade style, showing a small exposed portion of each layer, such as a title area or a corner area. Navigation between each layer in the stack can be through selection of that small exposed portion of the layer within the stack. The process of providing additional information (or resources) through multi-layered dialog box and the multi-layered dialog box are collectively called layered augmentation.

FIGS. 3A through 3C are flowcharts collectively illustrating an example process (or method) for augmenting web pages and providing viewers of augmented web pages with related advertisements through layered augmentation. In one embodiment, the illustrated method (or either of its sub-methods 300, 350, and 390) is implemented in a computing environment such as the computing environment 100. One or more portions of the method may be implemented in embodiments of hardware and/or software or combinations thereof.

By way of example, the illustrated method may be embodied through instructions for performing the actions described herein and such instrumentations can be stored within a tangible computer readable medium and are executable by a processor. Alternatively (or additionally), the illustrated method may be implemented in modules like those in the augmentation server 110 described above with respect to FIG. 2 and/or other entities such as the content providers 120 and/or the client computers 130. Furthermore, those of skill in the art will recognize that other embodiments can perform the steps of the illustrated method in different order. Moreover, other embodiments can include different and/or additional steps than the ones described here.

FIG. 3A illustrates an example process (or method) 300 for augmenting web pages. As illustrated in FIG. 3A with reference to components of the augmentation server 110 in FIG. 2, at an appropriate starting terminus 10, the method 300 begins by reading a piece of structured data from a source data file 30 at a block 13 (e.g., through the handler 36). The source data file 30 may be one designated by an input uniform resource locator (URL) address or by any suitable means to designate a resource. Upon opening the source data file 30, the method 300 may optionally identify the type of content on the page with a content identifier such as a MIME header (e.g., through the locator 42). In one embodiment of the invention, the method 300 merely searches for the presence of a piece of reference data (e.g., through the locator 42), either informed by the content identifier or by simply searching an occurrence of a piece of well structured data (e.g., a keyword) within the source data file. In addition, once the source data file 30 is open, the method 300 has its content available for comparison to reference data in the reference database 39. Other methods and examples to read a piece of structured data from the source data file are described in U.S. application Ser. No. 12/033,539, filed on Feb. 19, 2008, the content of which is incorporated by reference in its entirety.

At a block 16, the method 300 locates one or multiple pieces of reference data in the reference database 39 corresponding to the piece of structured data read in the source data file 30 (e.g., through the locator 42). In one embodiment, the locator 42 searches for reference data in the reference database 39 that match the piece of structured data by making function calls to the reference database 39. In one embodiment, the structured data are keywords, and the reference data also contain keywords.

Keywords are a facile and efficient means of generating layered augmentation. In addition to or instead of using keywords, one embodiment uses a “fuzzy expert” or a neural network analysis of the source data file 30, such as by a natural language search of the source data file 30 to generate a distinct identifier for the content in the source data file 30. One advantage of a natural language search is the ability to better place content in context making links more contextually appropriate, for instance, security might relate to security of a physical plant such as security of a residence in one source data file 30 in one context and security of a website in another. In one embodiment, the method 300 determines a context of the keywords and/or the source data file 30 based on statistical modeling (e.g., through the locator 42). For example, a context can be assigned a pre-defined set of terms which acts as a fingerprint for the context (hereinafter called context fingerprint). The locator 42 can compare the context fingerprints associated with a collection of contexts with the terms within the source data file 30 to determine a percentage match for each context in the collection. Where a high percentage match is achieved (e.g., exceeding a pre-defined percentage match threshold), the locator 42 determines that the associated context is the context for the source data file 30. Alternatively or in conjunction, the locator 42 may determine the context associated with the highest percentage match as the context for the source data file 30. The context can be used to locate corresponding reference data and/or related resources.

At a block 19, the method 300 generates an association to the piece of structured data based upon the located matching reference data (e.g., through the analyzer 45). In one embodiment, a piece of reference data includes an identifier such as a keyword, a context, a unique identification number, and/or associated URL address(es) of intended destination resource(s) based upon the occurrence of the corresponding keywords in the source data file 30. Generating an association means to associate the piece of structured data located in the source data file 30 with the located reference data in the reference database 39. The generated association might optionally include additional identification codes such as an association ID. The method 300 then augments the original source data file 30 with the generated association at a block 22 to generate an augmented data file 50 (e.g., through the generator 48).

In one embodiment, the method 300 expresses the association as intelligent tags (e.g., through the generator 48). The method 300 generates intelligent tags for the located keywords and tags the keywords with the generated intelligent tags. The intelligent tags contain information about the associated keywords such as the keyword and related context, and information about the associated reference data such as IDs that uniquely identify the reference data in the reference database 39. For example, the intelligent tags may contain requirement (or preference) information about advertisements (or other types of resources) to be associated with the keyword, such as types of advertisements and a minimum advertisement fee. In one embodiment, the intelligent tags also format the augmented keywords differently than the other textual content in the augmented web pages. Having generated the augmented data file 50, the method 300 then terminates at a block 25.

In one embodiment, the augmentation server 110 (or the content providers 120) also augments the web pages by including computer code (hereinafter called client code) to monitor and report viewers' interactions with the augmented keywords. The computer code can be in any computer language, such as JavaScript. Additional functions of the client code are described in detail below with respect to FIGS. 3B and 3C.

The augmented data file 50 can be delivered (or transmitted) to client computers 130 for display through a web browser to viewers to provide related resources through layered augmentation. The delivery of the augmented data file 50 and the process to provide layered augmentation is described in detail below with respect to FIGS. 3B and 3C. For purpose of illustration, the method is described in terms of web pages augmented with advertisements, even though the disclosed embodiments apply to other types of augmented data file and resources.

Referring now to FIG. 3B, a flowchart illustrating an example process (or method) 350 for providing layered augmentation to viewers of augmented web pages. As illustrated, the method 350 transmits 355 an augmented web page to a client computer. For example, a user of the client computer 130 may enter the URL of an augmented web page (or the corresponding original web page) in the address bar of a conventional web browser (e.g., Microsoft Internet Explorer™, Mozilla Firefox™, or Apple Safari™). The web browser of the client computer 130 (hereinafter called the client web browser) resolves the URL and transmits a request for the web page to a corresponding content provider. Responding to the request, the content provider transmits 355 the augmented web page to the client web browser for display. In one embodiment, the client web browser displays augmented keywords in a double underline style and/or in a color distinctive from text that is not augmented in the augmented web page.

The method 350 receives 360 an intelligent tag request from the client computer 130. As described above with respect to FIG. 3A, the augmented web page contains client code that monitors user interactions with augmented keywords. In one embodiment, if the user moves a pointer (e.g., a pointer controlled by a mouse, navigation button, or touchpad) over (a mouse-over) an augmented keyword (the activated keyword), the client code (which may be integrated with the web browser, for example, as a plug-in applet) generates an intelligent tag request and transmits the request to the augmentation server 110. The request indicates the mouse-over user activity to the augmentation server 110. The request may contain information that uniquely identifies the activated keyword (e.g., an association ID), and/or other information such as the activated keyword itself.

The method 350 determines 365 advertisements relevant to the activated keyword for the received request based on the keyword and/or the associated reference data. In one embodiment, the augmentation server 110 extracts the keyword and/or related context from the request, retrieves the associated reference data from the reference database 39, and determines 365 the relevant advertisements by searching in an advertisement database using the keyword and/or requirements set forth in the associated reference data (e.g., advertisement category, context, fee requirements, etc.).

In one embodiment, the method 350 determines 365 the advertisements that match the best (e.g., matching the activated keyword and/or satisfies the most number of reference requirements) as the relevant advertisements. In another embodiment, the method 350 determines 365 relevant advertisements based on a context of the augmented web page and/or the activated keyword. For example, for a key phrase “digital camera” in an article about digital camera, the method 350 may determines the following resources as relevant: a product review of a digital camera in CNET.com, a collection of user reviews at Buy.com, and a selection of similar digital cameras. The context can be determined when the activated keyword is identified in method 300.

In one embodiment, the method 350 determines a sequence for the related advertisements. The top advertisement in the sequence (also called the default advertisement or the primary advertisement) is the advertisement being displayed on the top layer of the layered augmentation. The lower ranked advertisements (also called secondary advertisements) are made available on lower layers of the layered augmentation. In one embodiment, the method 350 uses a bidding system to determine related advertisements sequence. For example, for a key phrase “digital camera,” there may be multiple related advertisements (e.g., advertisements for different brands or models of digital cameras), each having a bid (or budget or cost) for the key phrase. The method 350 may determine a sequence of the advertisements based on their bids, the one with the highest bid ranked the highest and so on.

In another embodiment, the method 350 may determine the sequence of multiple advertisements based on factors other than bidding prices. For example, the method may consider factors such as relationships among the multiple advertisements (e.g., prioritizing video advertisements over text ones), prior user interactions with the advertisements (e.g., prioritizing advertisements with higher interacting rate), and contexts of the augmented keyword (e.g., prioritizing advertisements from retailers or service providers having branches near a geographical context of the keyword and/or the augmented web page, or geographic locations of a substantial portion of viewers of the web page).

Further, specific sequences may be set for specific keywords and/or parties (e.g., content providers, advertisers, users). For example, if the keyword(s) is a music artist (or band, album) name, the method 350 may make available his songs (e.g., playback through an embedded music player) on the top layer and other resources on lower layers. As another example, if the keyword(s) is a location name (e.g., Yellowstone National Park), the method 350 may make available the relevant map (e.g., MapQuest™ Map) on the top layer. As noted above, the resources made available through the layered augmentation need not to be advertisements and can be related contents such as related articles, videos, images, music, to name only a few. For example, a content provider may specify that the layered augmentations in its web pages make available a set of links to its other relevant web pages (e.g., within the same website) where the keyword(s) being augmented is cross-indexed.

In one embodiment, viewers can set their preferences to determine a preferred sequence for the layered augmentation. For example, a viewer may prefer video advertisements while another may disfavor them (e.g., due to bandwidth constrains at receiving device). As a result, the method 350 may place video advertisements higher on a sequence for the first viewer, while not consider video advertisements for augmentation for the second viewer. Viewer preferences can be stored in a database such as the reference database 39 along with other viewer related data (e.g., profile data).

The method 350 transmits 370 the relevant advertisements to the client computer 130 for display. In one embodiment, the method 350 retrieves the advertisements from an advertisement database, and transmits 370 them to the client web browser (or the client computer) for display. Alternatively, the method 350 may transmit references of the advertisements (e.g., their URLs) to the client web browser for retrieval.

In one embodiment, the method 350 generates computer code (hereinafter called the advertisement code) to facilitate user interaction with the advertisements. Similar to the client code, the advertisement code can be in any computer language, such as JavaScript. The advertisement code may display the relevant advertisements in a multi-layered dialog box (or popup box) when the viewer moves a pointer over the activated keyword. The method 350 transmits the generated advertisement code along with the related advertisements to the client web browser. In one embodiment, the advertisement code is a part of the client code, and is integrated in the augmented web page when the page is generated

The client web browser displays 375 the relevant advertisements in a layered dialog box proximate to the activated keywords (or the position where the mouse-over is occurring) as an in-page overlay. In one embodiment, the client web browser utilizes the advertisement code to display the advertisements in a multi-layered dialog box. The advertisements are displayed according to their sequence. In one embodiment, only the top advertisement is displayed and the lower ranked advertisements are represented by selectable tabs. An example process of the operation of the advertisement code and the client code is described in detail below with respect to FIG. 3C.

Referring now to FIG. 3C, a flowchart illustrating an example process (or method) 390 of the client code and/or the advertisement code. As illustrated, the method 390 determines whether a pointer is positioned over an augmented keyword (the activated keyword), and if so, sets 392 the primary advertisement as the active advertisement, and displays 394 the active advertisement in a multi-layered dialog box overlaying the augmented web page in a position proximate to the activated keyword or the mouse-over. The multi-layered dialog box also displays multiple selectable (e.g., clickable) tabs representing the lower layers. The viewer can select a tab to request the multi-layered dialog box to display the corresponding layer. If the user selected a tab, the method 390 sets 396 the advertisement corresponding to the selected layer as the active advertisement and displays 394 it in place of the previously displayed advertisement.

The viewer can also interact with the currently displayed advertisement by selecting the advertisement. If the viewer selects the advertisement, the method 390 responds 398 to the user selection based on the nature of the user selection and the configuration of the advertisement. For example, if the user clicks on the active advertisement, the method 390 redirects the web browser to a web page related to the active advertisement. Alternatively, if the user drags a scrollbar displayed on the dialog box, the method displays different portions of the active advertisement as the user drags along the scrollbar. In one embodiment, if the viewer moves the pointer away from the activated keyword and/or the multi-layered dialog box for an extended period of time, the method 390 hides the dialog box.

Referring back to FIG. 3B, in one embodiment, rather than displaying multiple advertisements, the method 350 displays multiple aspects (or portions) of the same advertisement in the multi-layered dialog box. For example, the multi-layered dialog box may display an image and brief description of a product, and present two tabs, one for user reviews and the other for playback of a television advertisement of the product. The viewer may interact with the advertisement through the multi-layered dialog box without having to navigate away from and otherwise leave the current web page the viewer is interacting with in the web browser. For example, if the advertisement contains video, the multi-layered dialog box may overlay the video with video controls (e.g., forward, rewind, play/pause, volume, etc.). The multi-layered dialog box may also provide functional resources such as web searches, enabling viewers to conduct web searches and/or review search results without leaving the augmented web page.

The method 350 tracks 380 the received requests, the advertisements displays, and/or the user's interactions with the advertisements. These activities may be logged in a database (e.g., the reference database 39) or reported to another device or person (e.g., via electronic mail).

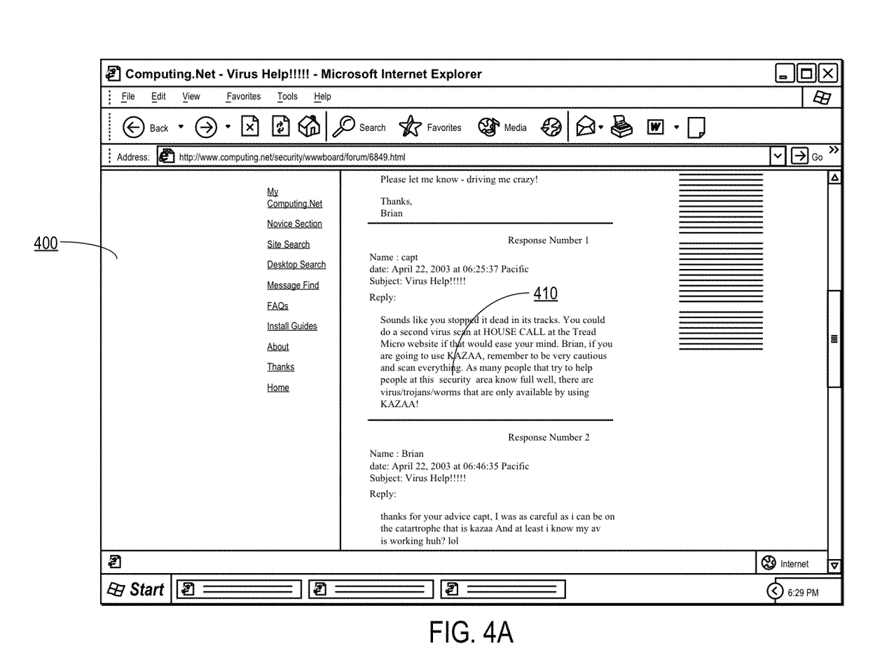

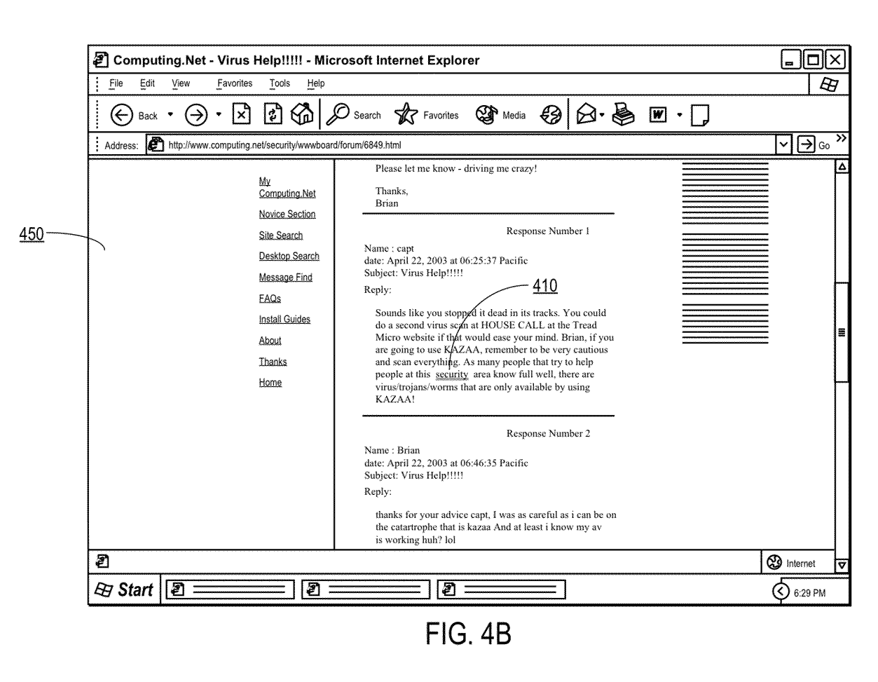

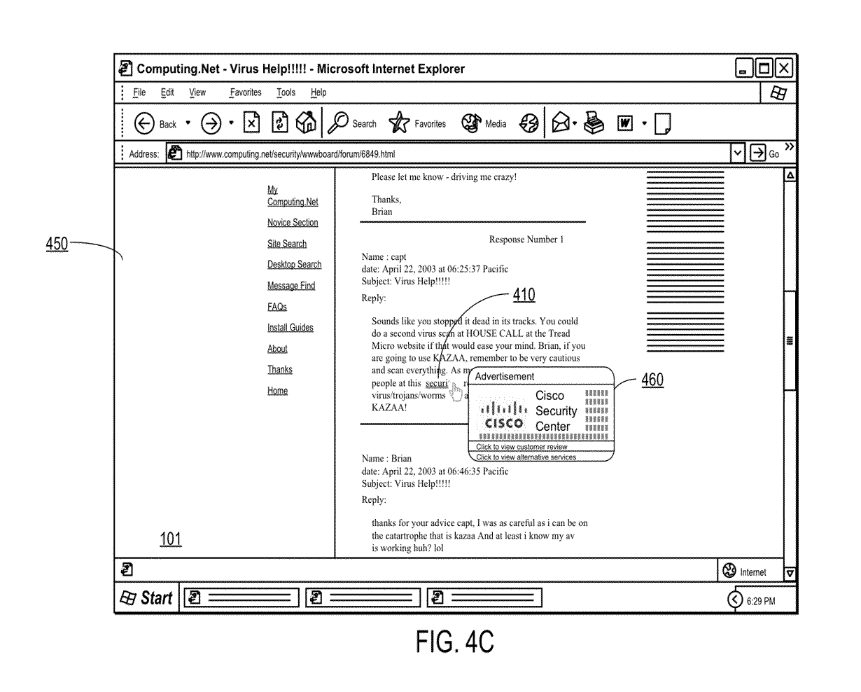

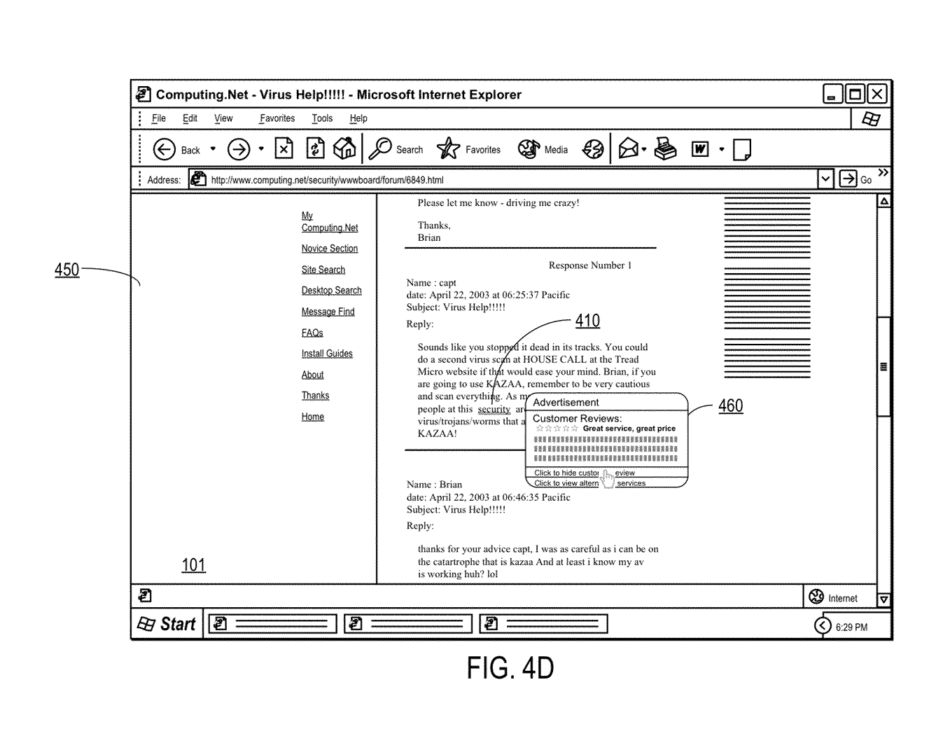

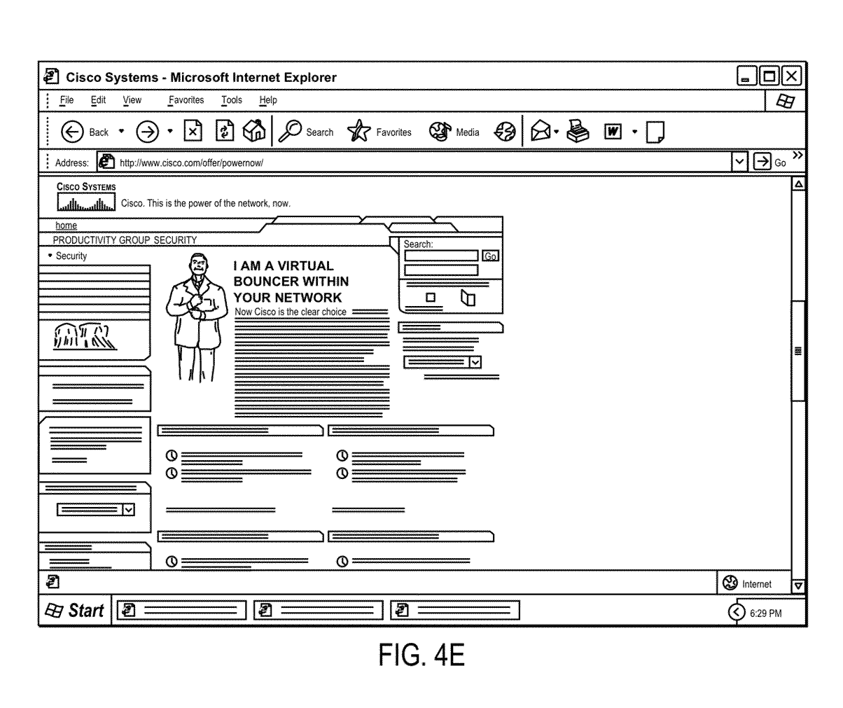

The methods described above with respect to FIGS. 3A through 3C are illustrated below in an example together with accompanying screenshots in FIGS. 4A through 4E. Initially, the augmentation server 110 retrieves a web page 400 for augmentation. The web page 400 may contain textual content of any subject. FIG. 4A shows an example of the web page 400 as displayed in Microsoft Internet Explorer™. As shown in FIG. 4A, the web page 400 is retrieved from website www.computing.net and contains a paragraph about computer virus.

The augmentation server 110 reads 13 the web page 400 for keywords. The augmentation server 110 identifies the keyword “security” 410 for layered augmentation. The augmentation server 110 locates 16 a piece of reference data matching the keyword “security” 410 and determines a context of computer security for the keyword 410. The piece of reference data includes an advertisement category for computer security services. The augmentation server 110 generates 19 an association of the keyword “security” 410 and the located piece of reference data.

The augmentation server 110 augments 22 the web page 400 by generating an intelligent tag encoding the generated association, and integrating the intelligent tag in an augmented web page 450. The augmentation server 110 also includes in the augmented web page 450 JavaScript code (client code) that captures user interactions with the augmented keyword 410.

A web browser running on a client computer 130 retrieves the augmented web page 450 and displays it to a user (e.g., responding to the user entering an URL of the web page 400 or 450 in the address bar of the web browser). FIG. 4B illustrates a screenshot of the augmented web page 450 as displayed on an Internet Explorer™ web browser after it is retrieved by the browser. It is noted that in FIG. 4B the augmented keyword 410 is displayed in a double underline style to distinguish from conventional hyperlinks that are single underlined.

Subsequently, the user may move a pointer (e.g., controlled by a mouse, stylus, or touchpad) over the double underlined augmented keyword 410 (the activated augmented keyword). This user action is also referred to as a mouse-over. Detecting the mouse-over, the embedded JavaScript code (the client code) in the augmented web page 450 (or the web browser) generates an intelligent tag request that uniquely identifies the activated augmented keyword 410 and/or the related context, and transmits the request to the augmentation server 110. The augmentation server 110 receives 360 the request, retrieves stored association of the keyword 410, and determines 365 relevant advertisements by searching for advertisements corresponding to the keyword 410 and/or the related context in an advertising database. In the present example, the augmentation server 110 determines 365 that an advertisement for Cisco security center is the relevant advertisement associated with the augmented keyword 410.

The augmentation server 110 determines a sequence of various parts of the Cisco advertisement and/or other relevant advertisements. In the present example, the augmentation server 110 determines that a description of the Cisco security center ranks top in the sequence, followed by its customer reviews, and a list of competing services.

The augmentation server 110 transmits 370 the related advertisement(s) back to the web browser for display. The augmentation server 110 also transmits JavaScript code (advertisement code) that enables layered representation of the transmitted advertisements.

The web browser (or the advertisement code) displays 375 the received advertisement(s) as an overlay in a multi-layered dialog box in proximity to the keyword 410 or the location where the mouse-over occurred. As illustrated in FIG. 4C, the user has moved a mouse pointer over the keyword 410. As a result, the web browser receives advertisements related to the keyword “security” 410 and displays them in a multi-layered dialog box 460 proximate to the pointer.

As illustrated, the multi-layered dialog box 460 displays an advertisement about CISCO security center. On the bottom of the multi-layered dialog box 460 are two tabs labeled “Click to view customer review” and “Click to view alternative services,” respectively. Note that this is consistent with the sequence of the advertisements (and/or advertisement portions) determined by the augmentation server 110. The user can navigate the advertisements within the multi-layered dialog box 460 by clicking the labeled tabs. The user can also visit the corresponding advertiser's web page by clicking the advertisement. While the user navigates within the multi-layered dialog box 460, the augmented web page 450 remains as the current web page displayed in the client web browser. The user can quickly resume browsing the rest of the augmented web page 450.

As illustrated in FIG. 4D, when the user clicks (or mouse-over) the tab labeled “Click to view customer review,” the multi-layered dialog box 460 displays customer reviews for Cisco security center. It is noted that the label on the tab representing customer review changes to “Click to hide customer review.” The user can click the tab to resume viewing the previous advertisement for Cisco security center.

As illustrated in FIG. 4E, when the user clicks the Cisco security center advertisement, the advertisement code redirects the client web browser to the advertiser's web page, in this case a web page related to Cisco security center.

C. Systems and Methods of an Ad Server Platform

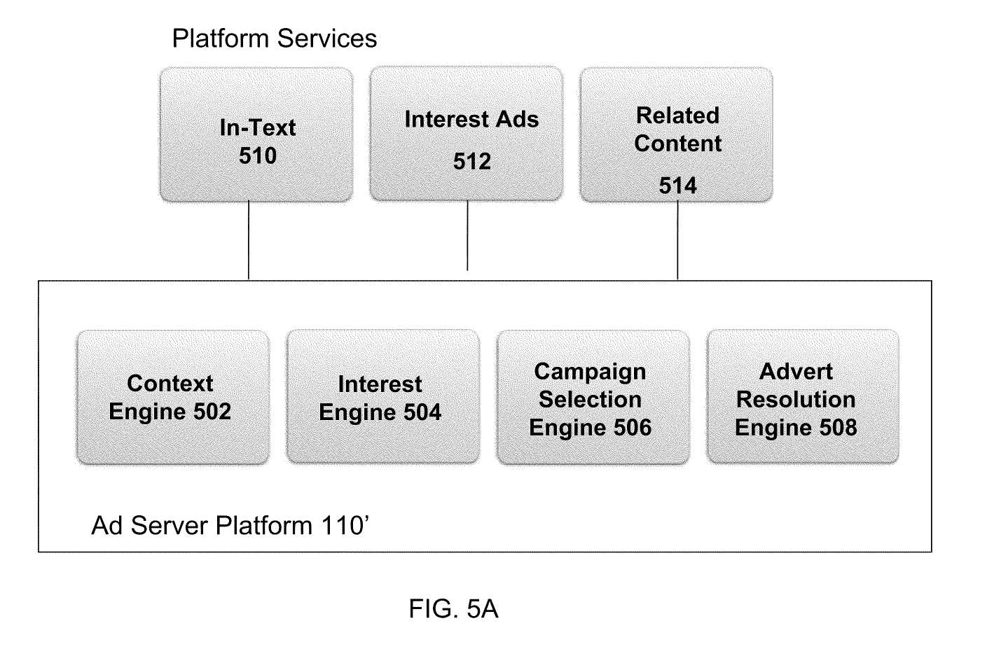

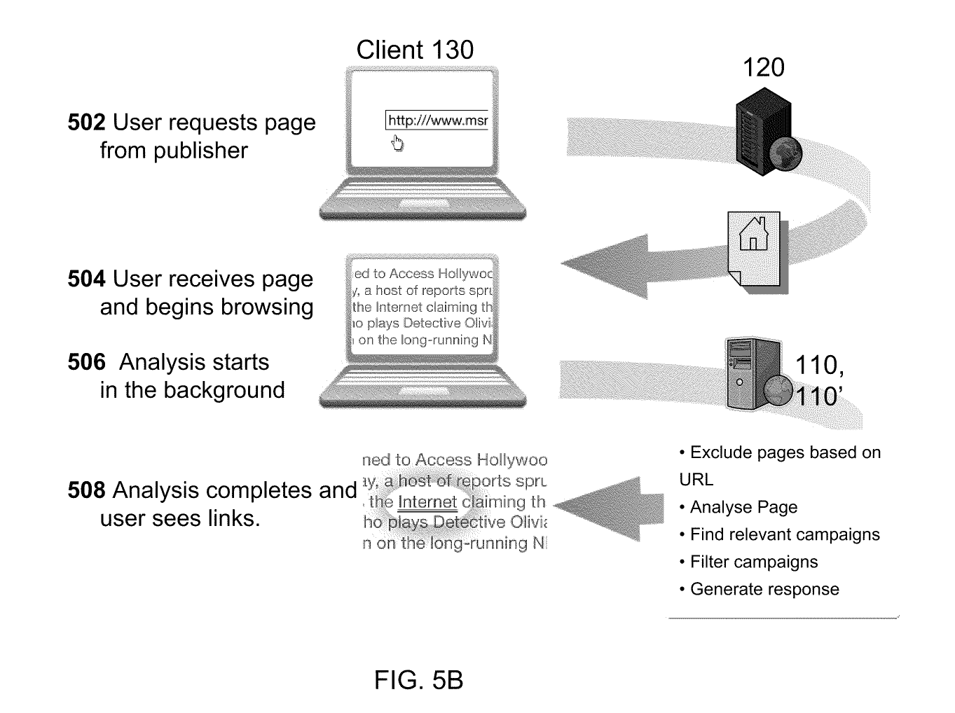

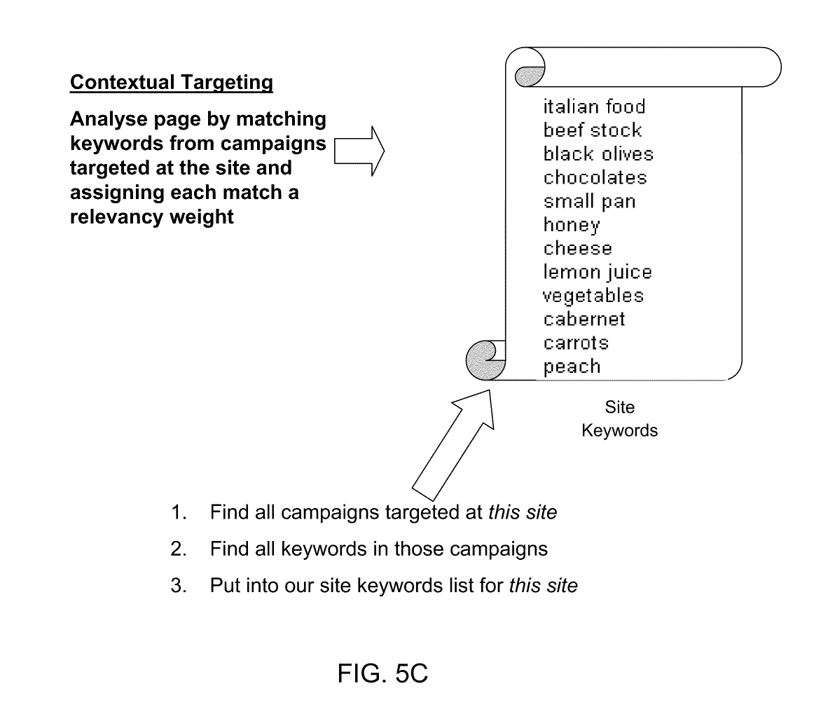

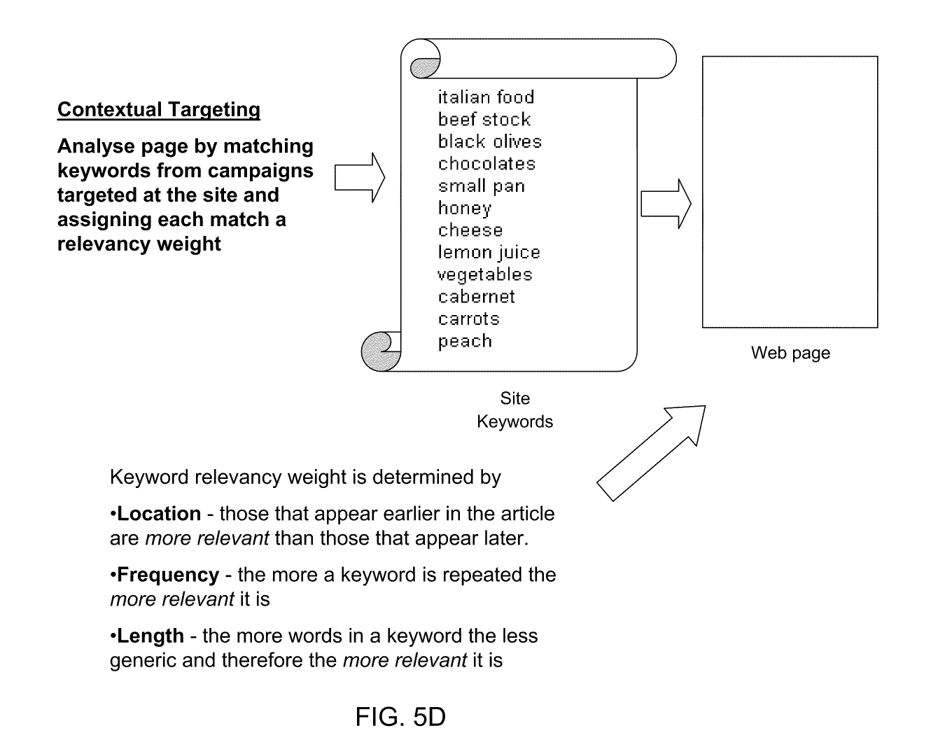

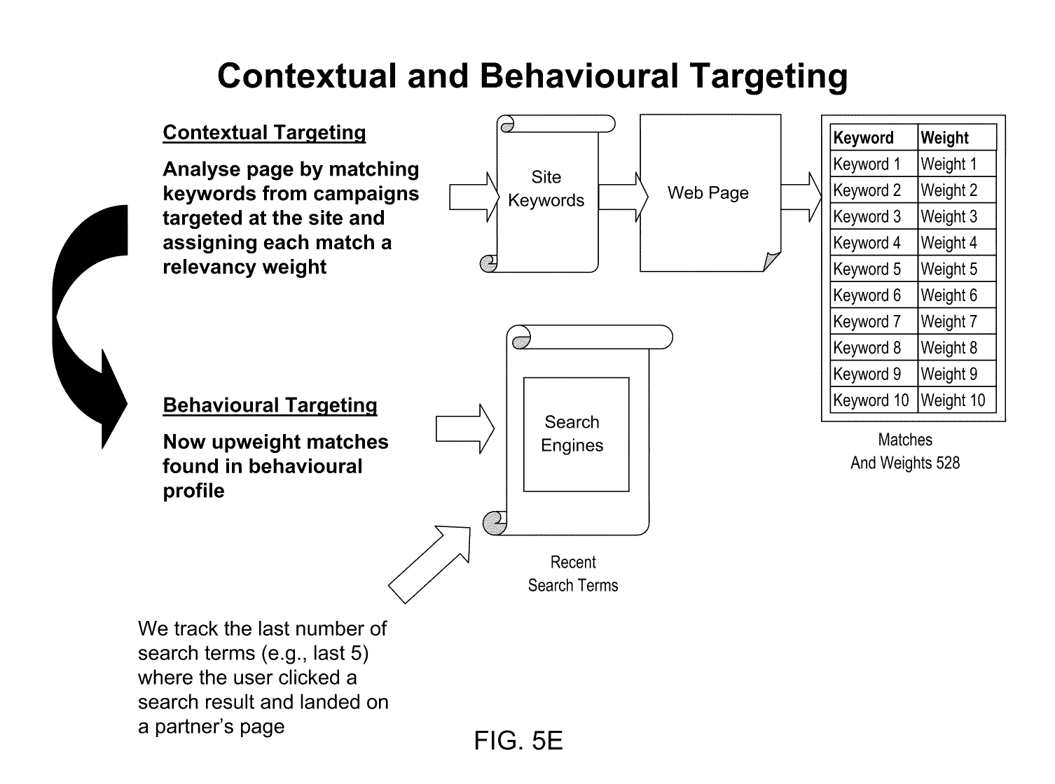

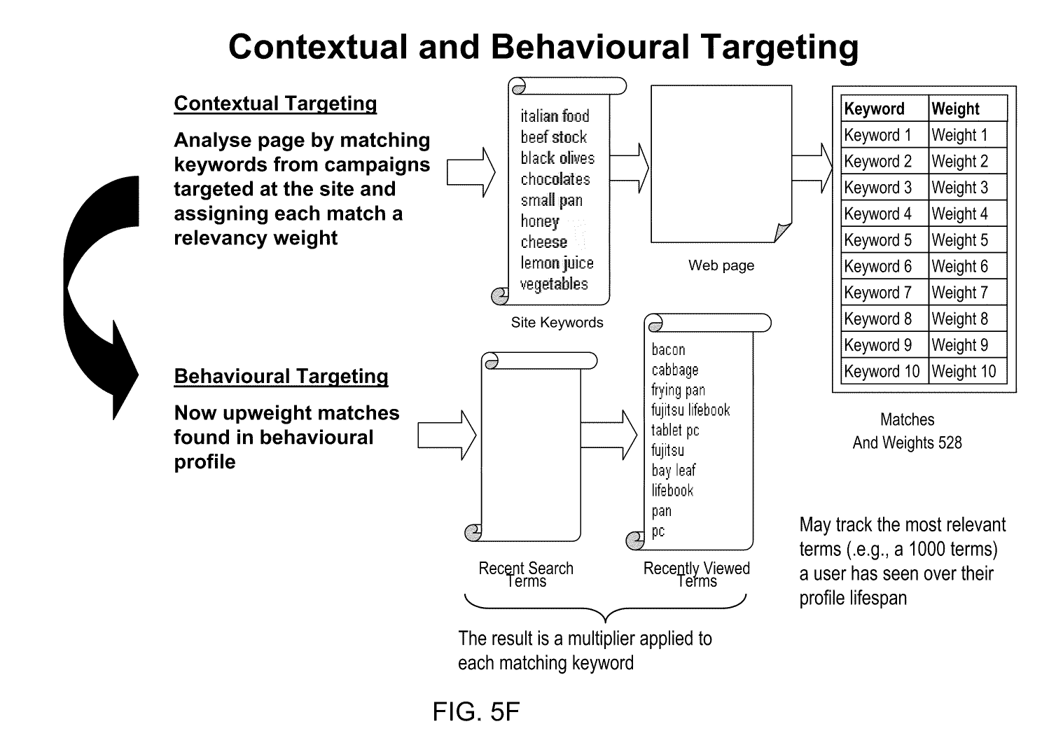

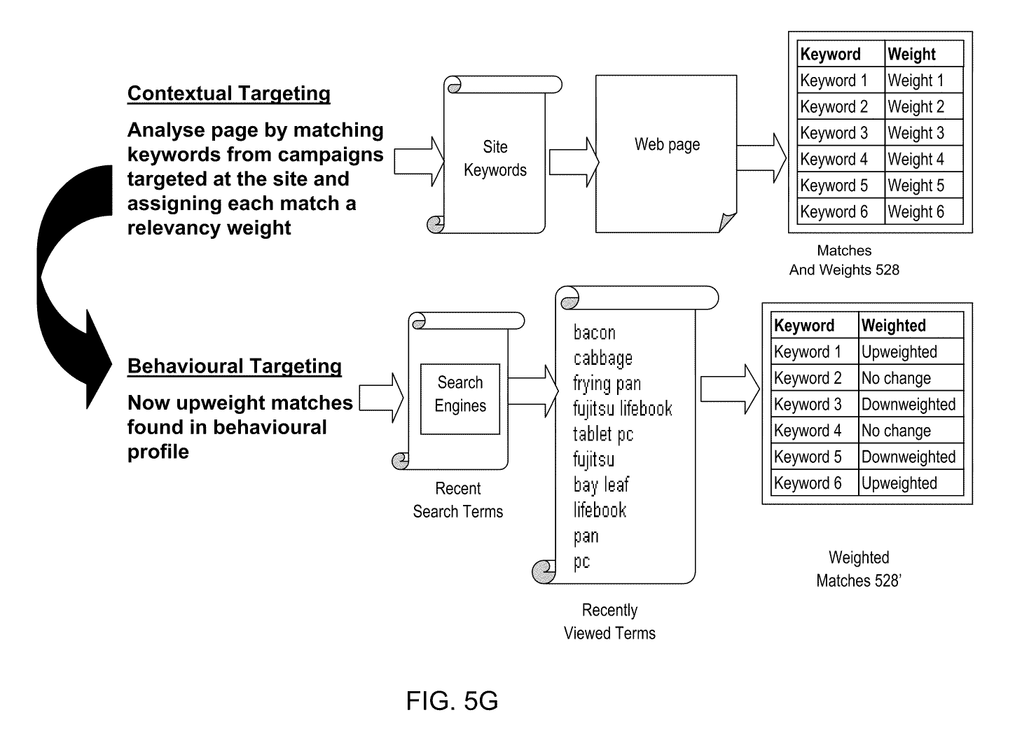

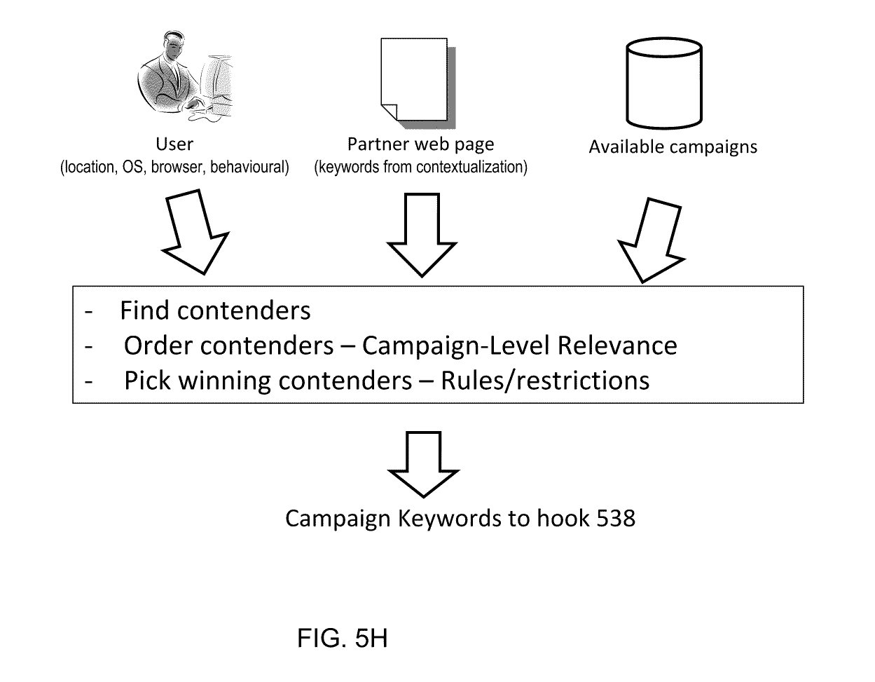

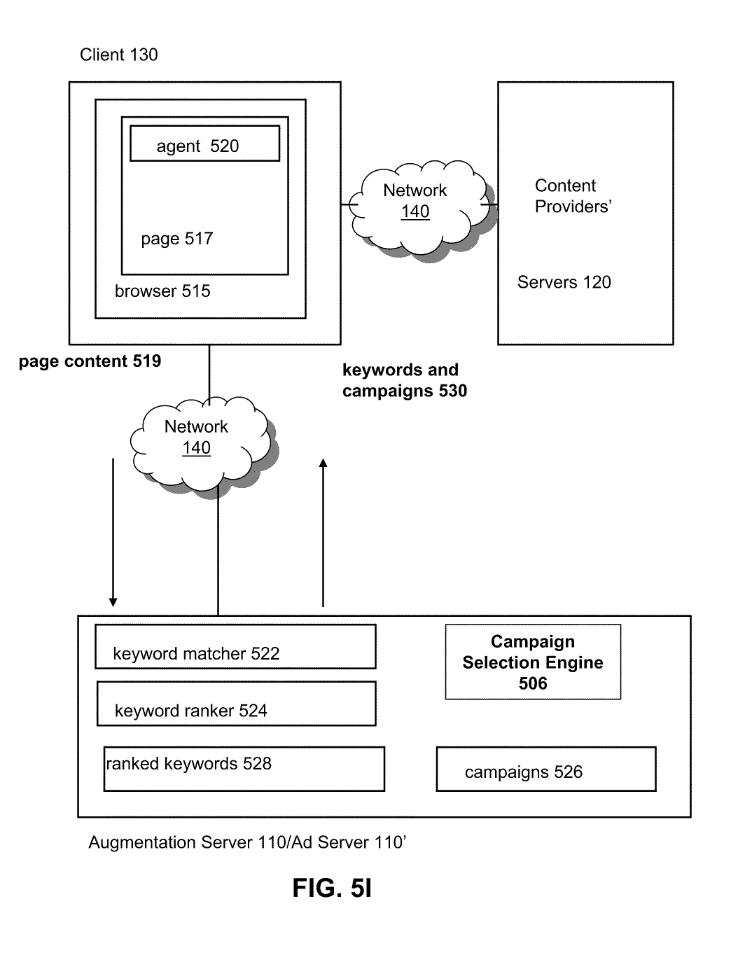

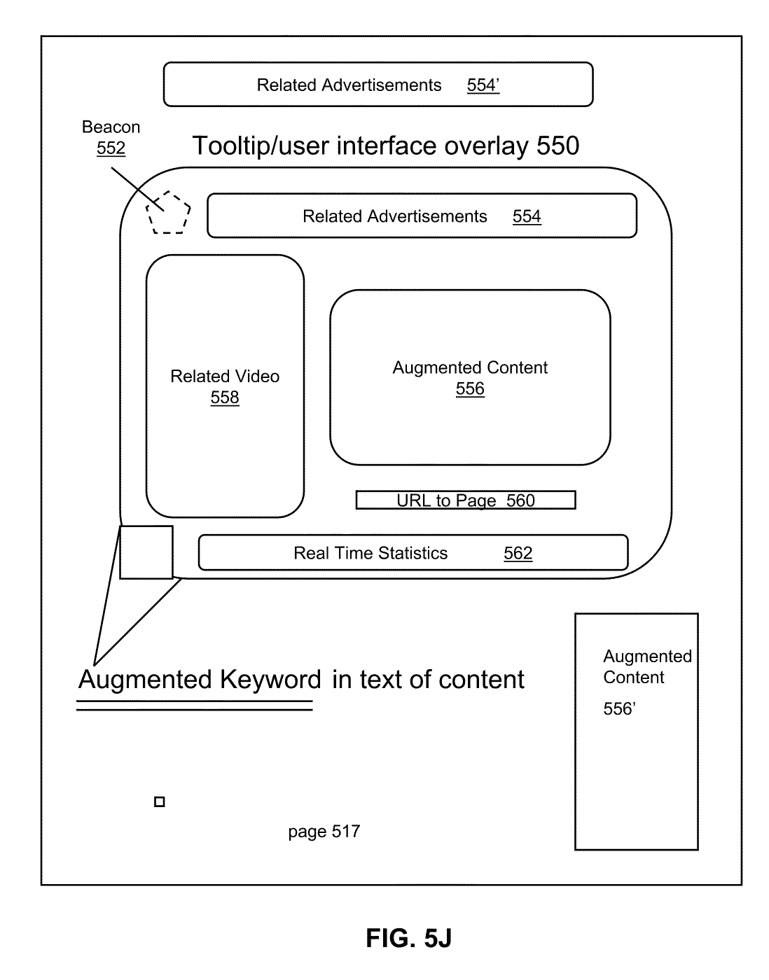

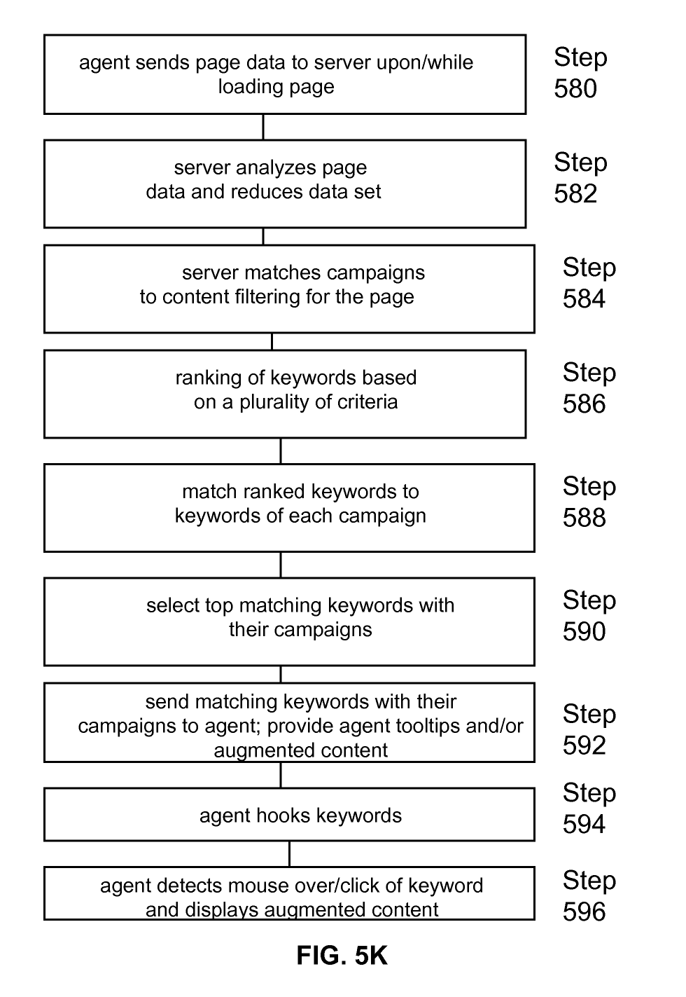

Referring now to FIG. 5A, an embodiment of an environment and systems for providing a plurality of augmented content and related services. In brief overview, an ad server platform 110′ delivers a plurality of services, such an in-text services 510, interest ads 512 and related content 514 services. The ad server platform 110′ may include a context engine 502, an interested engine 504, a campaign selection engine 506 and/or an advert resolution engine. The ad server may include or further include any embodiments of the augmentation server 110 described herein.

The ad server platform 110′ may comprise any combination of modules, applications, programs, libraries, scripts or any other form of executable instructions executing on one or more servers. The ad server platform 110′ may provide services directed to advertisers to reach a plurality of users across a plurality of publisher websites, such as content providers 120. The services of the ad server platform 110′ may combine the precise word targeting with delivery of rich media and video content. The ad server platform 110′ may provide services directed to publishers to received additional advertising revenue and real-estate with adding more clutter on their web-sites. The ad server platform provides a user controlled environment, allowed the user to view augmented content, such as advertising, only when these choose to via mouse interaction over a relevant word of interest—a keyword. As such, an ad impression may be pre-qualified in that a user must choose to view the ad by moving their mouse over or clicking on a word or phrase of interest. This may be referred to as user-initiation impressions.

The ad server platform may provide in-text advertising services 510. In-text services reads web pages and hooks words and word-phrases dynamically and in real time. The hooked words may be linked or hyperlinked to augmented content in any manner. In one embodiments, the words are double underlined but any type of indicator may be used such as a single underline or an icon. In some embodiments, the code for in-text services is installed by publishers into their sites and does not require any additional code, adware or spyware to be downloaded or uploaded by a user. When a user mouses over or clicks on hooked (e.g., double underlined) word or phrase, the code display a user interface overlay, sometimes referred to as a tooltip, on the web page and near the hooked word or phrase.

The ad server platform may provide interest ad services 512. The interest ad services identifies words of interest within a web page to deliver advertisements that are related to these words of interest. The interest ad service may identify the words on the page to analyze those words to determine which words are core or central to that page. These set of core word are keywords to identify one or more ad campaigns relevant to those keywords and the user's interests. This may minimize wasted impressions and deliver and advertising experience that relates more directly to the user's interest.

The ad server platform may provide related content services 514. The related content services may provide, create or generate an automated linking system that conveniently delivers relevant additional content from the same or different publishes in the form of videos, articles and information. The related content services may read web pages and hook words and word-phrases dynamically and in real time. The hooked words may point or navigate the user through content related to the hooked words available through a website, network or portal. For example, the related content service may link a word on the page to re-circulate the user through additional content, such as other web pages, of the publisher. In some embodiments, the related content service may automatically mirror the hyperlink style of a publisher's editorial links or already provided hyperlinks. The related content services may generate or add an icon, such as search icon, that indicates that augmented content is returned or available.

In further details, the ad server platform may comprise one or more context engines 502. The context engine may comprise any type and form of executable instructions executing on a device, such as a server. The context engine may comprise any functions, logic or operations for analyzing content of a web page. The context engine may use any type and form of semantics based algorithm to determine the meaning of the keyword relevant to the content of the page, the user, the web-site, the publisher and/or the campaign. The context engine may determine the intended structure and meaning of words, phrases, sentences or text in the content of the page. The context engine may analyze the text in the content to determine any characters, text, strings, words, terms and/or phrases, or any combinations thereof, that match or correspond to any characters, text, strings, words, terms and/or phrases, or any combinations thereof of any one or more campaigns. The context engine may analyze the content of the page for keywords from campaigns targeted at the web-site, publisher or content provider of the page. The context engine may determine any type of metrics on the content of the web page and of keywords of targeted campaigns of the web page. The context engine may use any type and form of algorithm to determine a keyword relevancy weight such as by location of the keyword, the frequency of the keywords and the length of the keyword. For example, for location weighting, those keywords that appear earlier in the content may be considered more relevant than those that appear later. For frequency relevancy, the more a keyword is repeated within the content, the more relevant the keyword may be considered. For length relevancy, the more words in a keywords the less generic the keyword may be and the more relevant the keyword may be considered.

The ad server platform may comprise one or more interest engines 504. The interest engine may comprise any type and form of executable instructions executing on a device, such as a server. The interest engine may comprise any functions, logic or operations for tracking and storing user information and/or behavior to a behavioral profile. The interest engine may track and store the user's location, operating system and/or browser. The interest engine may track a predetermined number of keywords a user has seen over a certain time period. The interest engine may track a predetermined number of relevant terms a user has viewed over a certain time period. The interest engine may track the a predetermined number of searches for which a user clicked a search result and landed on the content providers web-site or web. The interest engine may store the recent search terms and/or recently viewed terms into a behavioral profile for the user. The ad server platform, context engine and/or interest engine may change the weighting of keywords in content of a page responsive to any information stored in any behavioral profiles. For example, The ad server platform, context engine and/or interest engine may use a multiplier to upweight or downweight one or more keywords.

The ad server platform may comprise one or more campaign selection engines 506. The campaign selection engine may comprise any type and form of executable instructions executing on a device, such as a server. The campaign selection engine may comprise any functions, logic or operations for selecting or matching a campaign to a set of one or more keywords identified and/or weights for content of a page. The campaign selection engine may identify and select a campaign from a plurality of campaigns. The campaign selection engine may identify and select a first set of campaigns from a plurality of campaigns that meet a first threshold or criteria. From the first set of campaigns, the campaign selection engine may order or rank these campaigns using any type and form of algorithms. In some embodiments, the campaign selection engine may provide a campaign-level relevance of the keywords. The campaign selection engine may determine a relevance number or weighting for each campaign relative to the weighted keywords. In some embodiments, each campaign may provide a priority to keywords, web-pages or publishers. In some embodiments, each campaign may provide a relevance weighting to keywords, web-pages or publishers. The campaign selection engine may also comprise any set of one or more rules or restrictions for either changing the ranking, keeping a campaign or removing the campaign. Based on applying these rules and/or restrictions, the campaign selection engine selects from the first set of one or more companies a second set of one or more campaigns to use for augmenting the identified keywords on the web-page.

The ad server platform may comprise one or more advert resolution engines 508. The advert resolution engine may comprise any type and form of executable instructions executing on a device, such as a server. The advert resolution engine may comprise any functions, logic or operations for resolving the advertisement to use for a hook. For each advertisement, the advert resolution engine may determine whether the advertisement is a backfill or to be obtained from a backfill network. If the advertisement is backfill, the advert resolution engine calls or communicates with the backfill provider's servers. For example, the advert resolution engine may include one or more handlers designed and constructed to communicate with a particular backfill provider. When an advertisement is received from the backfill provider or when the advertisement if not coming from a backfill, the advert resolution engine may perform any type and form of filtering on the advertisement, such as for making sure the ad meets any rules or restrictions for content. The advert resolution engine includes a placer for selecting an instance of a keyword to hook with the advertisement. When the advert resolution engine has checked for backfill, filters the advertisement and selected an instance to hook for all the intended advertisements, the advert resolution engine may hook the keywords. The advert resolution engine may perform these operations for content other than advertisements, such as other types of augmented content.

Referring now to FIGS. 5B through 5H, diagrams of embodiments of the functionality and operations of the ad server platform are depicted. FIG. 5b depicts an embodiment of high level overview of the process from the client perspective. FIG. 5C depicts an embodiment of contextual targeting. FIG. 5D depicts an embodiment of keyword relevancy weighting. FIG. 5E depicts an embodiment of behavioral targeting. FIG. 5F depicts a further embodiment of behavioral targeting. FIG. 5G depicts an embodiment of further weighting based on behavioral targeting. FIG. 5H depicts and embodiment of campaign selection.

Referring to FIG. 5A, at step 502, a user on a client 120 requests a page from a publisher, such as a web page of a content provider 120. At step 504, the client receives the page and the browser loads the page. The user may start browsing the web page. At step 506, an agent on the page, such as a script starts an analysis in the background. The agent may be triggered upon loading of the web page or start the analysis upon receipt and/or loading of the web page. The agent may communicate with the ad server platform to perform any of the services of in-text advertising, related content or interest ads. For example, the agent may send content from the page for the ad server platform to analyze. In the background of the user viewing or browsing the web page, the ad server platform may analyze the page, find relevant campaigns filter campaigns and generate a response to the agent for hooking the keywords and identifying or delivering the augmented content. The ad server platform may not analyze pages based on filtering certain URLs. The ad server platform may analyze the content received from the agent, perform any of the services described herein and send the keywords to hook and the corresponding augmented content, such as advertisements from a campaign. At step 508, the analysis is completed and the user sees links to keywords, such as double underlined keywords. As described herein, the user may mouse over or click the hooked keyword and have the augmented content displayed.

Referring now to FIG. 5C, an embodiment of contextual targeting is depicted. This contextual targeted may be performed by the ad server platform and performed in the background while the page is being loaded and browsed/viewed by the user. The ad server platform receives page content from the client, such as via an agent. The ad server platform analyzes the page to match keywords to campaigns targeted to the web-site, page or URL. In some embodiments, the ad server platform finds all campaigns targeted to this site, finds all keywords in those campaigns and forms or generates a site keyword list for this site. The ad server platform may match the keywords from the site keyword list to keywords in the content from the page. The ad server platform may assign each matching keyword a relevancy weight.

Referring now to FIG. 5D, an embodiment of assigning a relevancy weight to each keyword to provide contextual targeting is depicted. The ad server platform may provide a relevancy weight to each keyword of the site keyword list matching content of the web page. The ad server platform may use any type and form of metrics or combinations of metrics to determine a relevancy weight. In some embodiments, the ad server platform uses a location, frequency and/or length metric to assign a relevancy weight to the matching keyword. The location relevancy weight may comprise an indicator or multiplier to those keywords that appear near the beginning or top of the web page relevant to those keywords that appear near the end of bottom of the web page. The frequency relevancy weight may comprise an indicator or multiplier to those keywords that appear more times on the same page or content than other keywords. The length relevancy weight may comprise an indicator or multiplier to those keywords that have more words in the keywords than single keyword or keywords with less words.

Each type of metric relevancy weight may be weighted the same or differently. Each metric relevancy weight may have it owns multiplier or factor that scales the weight for the keyword up or down according to the relevancy. The keyword may be up weighted and/or down weighted one or more times by each of the metric relevancy weights. A keyword relevancy weight may be up weighted by one metric relevancy weight while downloaded by another relevancy weight. For example, a keyword may be repeated several times and be upweighted or have a high multiplier based on the frequency relevancy weight while only found and repeated near the end of the page for a down weighting or low multiplier from the location relevancy weight. In some embodiments, a keyword may get a low relevancy weighting from each of the metric relevancy weightings. In some embodiments, a keyword may get a high relevancy weighting from each of the metric relevancy weightings. In some embodiments, a keyword may get a combination of low and high relevancy weightings from different relevancy weightings.

Referring now to FIG. 5E, an embodiment of applying behavioral targeting is depicted. The ad server platform may identify, track and store formation about a user's behavior in a behavioral profile. The behavioral profile may comprise a profile for one user or a plurality of users. Each of the user's profile data may be identified, tracked and managed via unique user identifiers. In some embodiments, the ad server platform may track a predetermined number of search terms, such as 5, that the user last searched. In some embodiments, the ad server platform may track a predetermined number of search terms for each search engine, such as the Google search engine, Microsoft Bing search engine, Yahoo search or Ask search engine. In some embodiments, the ad server platform may track a predetermined number of search terms for each search engine across a combination of search engines. In some embodiments, the ad server platform tracks and stores those search terms for which the user clicked a search result. In some embodiments, the ad server platform tracks and stores those search terms for which the user clicked a search result. In some embodiments, the ad server platform tracks and stores those search terms for which the user clicked a search result and landed on a web page of a predetermined content provider or publisher.

Referring to FIG. 5F, a further embodiment of behavioral targeting is depicted. The ad server platform may track and store in the behavioral profile of a user a history of terms the user has seen over a predetermined time period. In some embodiments, the ad server platform tracks terms has a user has viewed on a web page. In some embodiments, the ad server platform tracks terms the user has selected from a search or interacted with during the user's viewing history. In some embodiments, the ad server platform tracks terms of one or more search results from which the user has clicked through. In some embodiments, the ad server platform tracks viewed terms over a predetermined time period. In some embodiments, the ad server platform tracks viewed terms over a start of a behavioral profile of the user to current time.

The ad server platform may use any of the search terms and/or viewed terms from the behavioral profile to make a change to the relevancy weightings of the matching keywords. Those matching keywords that the use has searched or viewed previously will have their relevancy weightings increased or upweighted via a behavioral targeting multiplier. In some embodiments, the ad server platform may use a combination of recently searched and viewed terms to apply a multiplier to each matching keyword. The ad server platform may use any temporal threshold to determine which search terms and/or viewed terms to use for determining a multiplier to the relevancy weightings of the matching keywords. The ad platform may apply higher behavioral targeting multipliers to those keywords that were recently viewed and/or recently search within a predetermined time history. The ad platform may apply no or lower behavioral targeting multipliers to those keywords that were not recently viewed and/or not recently search within the predetermined time history.

As a result of using behavioral profile data and behavioral targeting multipliers, as depicted in FIG. 5G, the ad server platform modifies the relevancy of the matching keywords from the site keyword list. The matching keywords are assigned a first relevancy weighting from the contextual targeting and are modified or changed to a second relevancy weighting from the behavioral targeting. In some embodiments, the ad server platform maintains both the contextual targeting relevancy weightings and the behavioral targeting relevancy weighting for each matching keyword. In some embodiments, the ad server platform maintains a single relevancy weighting keyword comprising the behavioral targeting multipliers (up weighting or down weighting) to the relevancy weighting applied by the contextual targeting.

Referring to FIG. 5H, an embodiment of campaign selection is depicted. In some embodiments, the results of contextual and/or behavioral targeting are used as input to the campaign selection engine. The ad server platform may use the relevancy weightings of the matching keywords from the site keyword list to determine which campaigns may be applicable to these matching keywords. Those campaigns not having keywords corresponding to any of the matching keywords may be dropped from consideration. In some embodiments, those campaigns not having a number of keywords corresponding to the matching keywords within a predetermined threshold may be dropped from consideration. In some embodiments, those campaigns having one or more keywords corresponding to a predetermined number of the top relevancy weighted keywords may be identified for consideration.

The ad server platform may order the list of campaigns under consideration using any type and form of algorithm. For example, the ad server platform may rank the campaigns based on having matching keywords with the highest combined relevancy weightings. the ad server platform may rank the campaigns based on having the highest number of matching keywords. The ad server platform may rank the campaigns based on a combination of the highest combined relevancy weightings and the highest number of matching keywords. The ad server platform may also order campaigns based on any type of priorities assigned to the campaigns. Some campaigns may have a high order of priority to deliver or serve than other campaigns.

The ad server platform may selected the campaigns to deliver from the ordered or ranked list of campaigns. The ad server platform may further restrict the selection based on any rules or policies of the ad server platform, the publisher or the campaign. For example, the campaign or publisher may have rules restricting the serving of a campaign directed to certain users, times of days, locations, browsers, or content. Once the selection of the one or more campaigns is made, the ad server platform generates a list of campaign keywords to hook and transmits these keywords to the agent of the client. The ad server platform may provide to the agent information on the publisher, campaign, tooltip/user interface overlay and/or augmented content with or corresponding to the keyword.

Referring now to FIGS. 5I, 5J and 5K, embodiments of systems and methods for delivering augmented content are depicted. FIG. 5I depicts an embodiment of a system for analyzing content of a page to determine keywords to augment for one or more campaigns. FIG. 5J depicts an embodiment of augmented content delivered to a web page of a client. FIG. 5k depicts embodiments of a method for analyzing and hooking keywords on a web page of a client.

In brief overview of FIG. 5I, an embodiment of a system for augmented keywords on a web page is depicted. A client 130 communicates with one or more content providers 120, such as publishers, via network(s) 140. The client 120 may include a browser that receives, loads and display content in the form of web page or pages 517 from the one or more contents providers. The client 130 also communicates with the augmentation server or ad server 110′. The page 517 being loaded or loaded by the browser comprises an agent 520. The agent 520 may communication page content 519 to the server 110, 110′ for analysis and received from the server 110, 110′ keywords, corresponding campaigns and/or augmented content. The keyword matcher 522 of server 110, 110′ may perform keyword matching, such as using site keyword list, on the page content 519 received from the agent 520. The keyword ranker 524 ranks the keywords to provide ranked keywords 528. The campaign selection engine 506 selects campaigns 526 based on the ranked keywords 528.

In further detail, the browser 515 may comprise any type and form of executable instructions for accessing information resources via a network 140 such as the Internet. The browser may include any user agent or software for retrieving, presenting, accessing and/or traversing information resources or documents on the world wide web or a network 140. The browser may include any functionality for loading, running, processing and/or displaying on a computer screen information written in HTML, XML, javascript, java, flash or any other language or a script used for web pages. Browser may include any functionality for displaying any type and form of content or features presented by web page or transmitted content provider 120. Browser may include any functionality for enabling a user to interact or interface with a web page. Browser may provide functionality for displaying advertisement information within a web page presented or displayed on a computer screen of client computer 130. In some embodiments, a browser is any version of Internet Explorer web browser manufactured by Microsoft Corp. In other embodiments, the browser is any version of the Chrome web browser manufactured by Google Inc. In other embodiments, the browser is any version of Firefox web browser distributed by the Mozilla Foundation. In further embodiments, the browser is any version of the Opera browser by Opera Software ASA.

The page 517 may include any type and form of content processable by any embodiment of the browser 515. The page may be stored on any number of servers, such as content providers 120 and may be accessed and/or loaded by any web browser, such as browser 515. The page may be a web page. The page be a document, The page may be a file. The page may any resource accessible via a network or a world wide web by a networked device, such as a client computer 130. The page may be identified by a URL. The page may include content from a URL. The page may include any type and form of executable instructions, such as scripts, AJAX. The page may include any type and form of graphics and/or text. The page may include any type and form of media, such as video or audio media. The page may include content having text, words, keywords and links or hyperlinks to other web pages or web sites.

Page 517 may include any document which may be accessed, loaded, viewed and/or edited by a browser 620 and displayed on a computer screen. Page 517 may include any content which may be presented via hypertext markup language, extensible markup language, java, javascript or any other language or script for preparing web pages. Web page may include any type and form of components for adding animation or interactivity to a web page, such as Adobe Flash by Adobe Systems Inc. The page may include functionality for displaying advertisements, such as advertisements from enterprises, government, companies and firms. A web page may include any number of ad spaces providing space or arrangement within web page for displaying advertisement.

The client, browser or page may include an agent 520. The agent may include any type and form of executable instructions executable by the browser and/or client. In some embodiments, the agent comprises a script, such as JavaScript or JSON (JavaScript Notation). In some embodiments, the agent may comprise any type and form of plug-in, add-on or component to or of browser 515. In some embodiments, the agent may comprise any type of application, program, service, process or task executable by the client.

The agent 520 may be included in the page 517 when transmitted by the content provider. In some embodiments, the page includes the agent in script form as part of the content of the page. In some embodiments, the page includes a URL to the script, such as URL pointing to or identifying a resource or script of the servers 110, 110′. In some embodiments, the agent is loaded by the browser. In some embodiments, the agent is executed by the browser upon retrieval and/or loading of the page 517. In some embodiments, the page includes instructions to the browser or client to obtain and load or install the agent.

The agent 520 may include any logic, function or operations to interface to or communicate with any portion of the augmentation server 110 or ad server platform 110. The agent may include any logic, function or operations to provide any of the services or functionality of in-text 510, interest ads 512 and/or related content 514. The agent may include any logic, function or operations to identify, collect and transmit content from the page to the server 110/110′. The agent may identify, collect and transmit any and/or all text in content of the page. The agent may identify, collect and transmit any and/or all text from any pages or URLs referred to by the page. The agent may transmit any embodiments of this page content 519 to the server 110, 110′.

The agent may comprise any logic, function or operations to receive keywords, campaigns and/or augmented content from the server 110, 110′. The agent may comprise any logic, function or operations to hook keywords identified in the page content. The agent may “hook” keywords by modifying the keyword in the page content to have an indicator, such as double underlined or an icon. Hooking a keyword refers to making a keyword on the page have a predetermined visual appearance to indicate that interactivity would or may occur by the user interacting with the keyword and instrumenting the page or keyword to perform the interactivity responsive to the user interaction. The indicator may provide a visual indication that the keyword in the text is linked or hyperlinked. In some embodiment, the agent may link or hyperlink the keyword. The agent may hook the keyword to include a function, script or executable instruction to take an action responsive to a mouse over, mouse click or other user interaction. The agent may hook the keyword to display a user interface overlay or tooltip such as depicted in FIG. 5J. The agent may hook the keyword to display a related advertisement or augmented content on the page as also depicted in FIG. 5J.

The keyword matcher 522 of the server 110, 110′ may comprise any type and form of executable instructions executable on a device. The keyword matcher may comprise any logic, function or operations to identify matches between one data set and another data set. In some embodiments, the keyword matcher may identify matches between keywords of campaigns with page content. In some embodiments, the keyword matcher may identify whole or complete matches. In some embodiments, the keyword matcher may identify partial or incomplete matches. In some embodiments, the keyword matcher may identify partial or incomplete matches within a predetermined threshold. In some embodiments, the keyword matcher may identify both complete and incomplete matches. The keyword matcher may perform any of the keyword operations described in connection with FIGS. 5A through 5F. The keyword matcher may be included as part of the context engine, interest engine or campaign selection engine of the ad server platform.

The keyword ranker 522 of the server 110, 110′ may comprise any type and form of executable instructions executable on a device. The keyword ranker may comprise any logic, function or operations to rank a set of data responsive to one or more criteria. The keyword ranker may comprise any logic, function or operations to rank keywords matched to page content. The keyword ranker may comprise any logic, function or operations to provide a weighting to a keyword based on any metrics of the keyword, such as location, frequency, and length. The keyword ranker may comprise any logic, function or operations to provide a weighting to a keyword based on relevancy to the site. The keyword ranker may comprise any logic, function or operations to provide a weighting to a keyword based on relevancy to a publisher or content provider. The keyword ranker may comprise any logic, function or operations to provide a weighting to a keyword based on relevancy to a campaign. The keyword ranker may comprise any logic, function or operations to provide a weighting to a keyword based on relevancy to a user or behavioral profile. The keyword ranker may be included as part of the context engine, interest engine or campaign selection engine of the ad server platform.

The keyword ranker may perform any of the keyword ranking and/or weighting operations described in connection with FIGS. 5A through 5F. An output or result of the keyword ranker may be ranked keywords 528. The ranked keywords may include any type of object, data structure or data stored in memory or to storage. The ranked keywords may include contextually targeted ranked keywords as described in connection with FIGS. 5A through 5F. The ranked keywords may include behavioral targeting ranked keywords as described in connection with FIGS. 5A through 5F. The ranked keywords may include any combination of contextually targeted ranked keywords and behavioral targeting ranked keywords. The ranked keywords may be site specific. The ranked keywords may be campaign specific. The ranked keywords may be publisher specific. The ranked keywords may be based on any combination of site, campaign and/or publisher.

The campaign selection engine 506 may interface or communicate with any of the keyword matcher, the keyword ranker and/or ranked keywords. The campaign selection engine 506 may access, read or process campaigns 526. The campaigns 526 may be stored in any type and form of database or file system. The campaigns 526 may include information identifying keywords for the campaigns and augmented content to deliver for those keywords. The campaigns 526 may include any type and form of content, URLS, scripts, video, audio, advertisements, media, text, graphics, data, information etc. to provide as augmented content with the keywords. The campaigns 526 may include any type and form of URLs, advertisements, media, text, graphics, etc. to provide as augmented content with the keywords. The campaigns may identify or provide any desired user interface overlay/tooltip or content therein. The campaigns may be organized by publisher. Each publisher may have a plurality of campaigns.

The campaign selection engine selects the campaign to deliver with the page based on analysis of the page content from the keyword matcher, keyword ranker and ranked keywords. The campaign selection engine may comprise any type and form of logic, functions or operations to identify and select one or more campaigns from a list of contender or candidate campaigns based on any criteria or algorithm. The campaign selection engine may select those campaigns that best match or correspond to the top ranked keywords. The campaign selection engine may select those campaigns that match or correspond to a predetermined number of ranked keywords. The campaign selection engine may select those campaigns that match or correspond to a predetermined set of ranked keywords. The campaign selection engine may select those campaigns that match or correspond to the ranked keywords in accordance with a priority assigned to the campaigns or publisher. The campaign selection engine may exclude or include campaigns based on the logic or criteria of any rules or filters.

Responsive to the campaign selection engine, the server 110, 110′ may transmit to the agent identification of one or more keywords to augment on the page and corresponding campaigns for those keywords (see 530). The server may transmit to the agent any script, data or information to provide or facilitate hooking of the keywords on the page and displaying the campaign responsive to user interaction with the keyword. The server may transmit to the agent the indicator, or identification of the indicator) to use for a hooked keyword. The server may transmit to the agent the type and form of user interface overlay to display when a user mouse over or mouse click occurs for the keyword. The server may transmit to the agent a reference to or identification of any of augmented content to display when a mouse over or mouse click occurs for the keyword. The server may transmit to the agent the augmented content, such as the advertisement, to display when a mouse over or mouse click occurs for the keyword.

The agent may receive the information 530 from the server and modify the page or content of the agent to perform the hooking of the keywords, to instrument the hooked keywords, and/or deliver the campaign responsive to the keyword. The agent may perform any of the agent's logic, functions or operations while the web page is being loaded. The agent may perform any of the agent's logic, functions or operations while the user views or browsers the web page. The agent may perform any of the agent's logic, functions or operations in the background to the user viewing or browsing the page.

Referring now to FIG. 5J, embodiments of augmented content delivered with a corresponding keyword is depicted. In brief overview, the page 517 may include an augmented keyword in the text of the content (e.g., see double underlined “Augmented Keyword” next to “in text of content”). When a user interacts with the augmented keywords, a user interface overlay 550, also referred to as tooltip, may be displayed. This user interface overlay may deliver or provide the campaign corresponding to the keyword. Responsive to user interaction with the keyword, the agent may display related advertisements 554′, such as via a banner ad, or augmented content 556′. The related advertisements 554′ and/or augmented content 556′ may be displayed in connection with the tooltip, without the tooltip or instead of the tooltip.

Any of the content on page 517 may include any embodiments of the advertisements and/or augmented contented provided and discussed above in connections with FIGS. 1 through 4E. The tooltip may be part of a multi-layered augmentation content or advertisement unit. The tooltip may provide any one or more URLs to access related websites.

The user interface overlay 550 referred to as a tooltip may include any type and form of web beacon 545. In some embodiments, the tooltip 550 may include a plurality of web beacons. The beacon may be used for tracking a user's usage and/or interactions with the tooltip. The beacon may identify or track a length of time of any user interaction with the tooltip and/or augments keyword or inline text. The beacon may identify a URL or tracking system to register or send communications regarding the user interaction. In some embodiments, a web beacon may be designed and constructed for a predetermined tracking system.

A web beacon may be an object that is embedded in the tooltip that is not visible to the user. Sometimes beacons are referred to as web beacons, web bugs, tracking bugs, pixel tags or clear gifs. Web beacons may be used to understand the behavior of users who frequent designated web pages. A web beacon permits a third party to track and/or collect various types of information. For instance, a web beacon may be used to determine who is reading a webpage, when the webpage is read, how long the page was viewed, the type of browser used to view the webpage, information from previously set cookies, and from what computer the webpage is accessed.

The tooltip may be incorporated, integrated or presented with any one or more of related advertisements 554, related video 558 and/or real time statistics 562. The tooltip 550 may include an URL 560 to any web page or resource, such as additional content, search results, or media. Although the tooltip 550 is illustrated each with a related advertisement, related video and related statistics, the tooltip 550 may be presented with one of these related content or a plurality of these related contents. Although this related content is illustrated in a location, size and position in relation to the tooltip, the related advertisements, related video, and/or real time statistics may be arranged, organized or presented in any manner.

The tooltip may also include one or URLs 560, such as a hypertexted URL or link to any other page or content. In some embodiments, the hypertexted link 560 comprises a URL of a landing page of a web site. In some embodiments, the hypertexted link 560 comprises a URL of a web page providing search results directly from the search engine. In another embodiment, the hypertexted link 560 provides a link to a recommend or most relevant search result. In other embodiments, the hypertexted link 560 provides a link to run the search query on a second search engine. The hypertexted link 560 may bring the user to a landing page of the search results of the second search engine.

The related advertisements 554 may include any type and form of advertisement related to the augmented content or inline text or otherwise related to the keyword. In some embodiments, the related advertisements are advertisements provided as described in connection with any of the embodiments of the FIGS. 1A-4E. In some embodiments, the related advertisements are advertisements provided by a search engine, such as in relation to and based on the search query. In other embodiments, the related advertisements are provided by any type and form of ad network via the server 110, 110′ and/or search engine.

The related video 558 may include any type and form of video media related to the augmented content or inline text or otherwise related to the keyword. In some embodiments, the related videos are advertisements provided as augmented content as described in connection with any of the embodiments of the FIGS. 1A-4E. In some embodiments, the related videos are videos provided by a search engine, such as in relation to and based on a search query. In other embodiments, the related videos are provided by any type and form of video service, such as YouTube.com or iTunes.com. In another embodiment, the related videos are videos available to the user via a user accessible storage or video management system.

The real time statistics 562 may include any type and form of statistics related to the augmented content or inline text or otherwise related to the keyword. In some embodiments, the real time statistics 562 may be any statistics related to the person or entity of the search. For example, if the augmented keyword is a sports team, the real time statistics may include current or recent game scores and/or standings of the team. In another example, if the augmented keyword is related to the weather, the real time statistics may include a current weather forecast. In one example, if the augmented keyword is related to a musician, the real time statistics may include statistics on music downloads, album sales and top music chart location.

Referring now to FIG. 5K, embodiments of a method for augmented content of a keyword of a web page being loaded into a browser is depicted. In brief overview, at step 580, an agent of the browser sends page data to server 110, 110′ upon or while loading a web page. At step 582, the server analyzes the page data and reduced the page data set. At step 584, the server performs content filtering on page and keywords to match to corresponding campaigns. At step 586, the server performs ranking of keywords. At step 588, the server matches the ranked keywords to keywords of each campaign. At step 590, the server selects top matching keywords and their campaigns. At step 592, the server sends to the agent the selected keywords and their campaigns and may provide the agent tooltips and/or augmented content. At step 594, the agent hooks the keywords identified by the server. At step 596, the agent detects user interaction such as mouse over or clock of keywords and displays augmented content, such as a tooltip.

In further details, at step 580, the agent may be executed by the browser upon or while loading the web page. The browser may retrieve the agent via a URL identified by the page. In some embodiments, the page transmitted by the server includes the agent. The agent may comprise script places or arranged at or near the top page to be executed by the browser. In some embodiments, the agent may be triggered by any load events or APIs of the browser. The agent may be executed prior to content of the web page being loaded or displayed. The agent may be executed prior to the retrieval of any URLS of the page. The agent may be executed prior to completion of loading of the web page by the browser.

The agent may identify, gather and aggregate data from the page. The agent many identify all text portions of the web page. The agent many identify those elements of the page that contain text. The agent may identify text from a predetermined set of elements of the page. The agent may identify text from HTML, XML or other page languages. The agent may identify text from the body of an HTTP portion of the page. The agent may perform text recognition on any portion of the page or any element of the page. The agent may identify text from any URLS or other content referred to or loaded by the page. The agent may identify any other date of the page, including headers. For example, the agent may identify the browser type, the user, location, IP addresses from the content of the page or from any of the network packets used for communicating the page. In some embodiments, the agents performs analysis and identified metrics for the page date, such as text location, frequency, length and repeatability.

The agent may gather the identified page data, text or otherwise, and/or any page metrics and transmits the page data and/or page metrics to the server 110, 110′. In some embodiments, the agent transmits the page data together in one transaction with the server. In some embodiments, the agent transmits portions of page data in a series of transactions with the server. In some embodiments, the agent transmits the page data using any type and form of protocol. In some embodiments, the agent transmits the page data as a background process to the browser loading the page or the user browsing the page. In some embodiments, the agent transmits the page data while the browser is loading the page.

At step 582, the server analyzes the page data and reduces the page data to a working set of page data to continue analysis. The server may remove a predetermined set of commons words, such as a, and, the, from the page data. In some embodiments, the server may filer a predetermined set of words, phrases, terms or characters according to any filters, rules or policies. In some embodiments, the server may identify and correct any typos or other inadvertences with the page data. In some embodiments, the server may perform any type and form of metrics on the page data. In some embodiments, the server may identify location, frequency, repeatability of text on the page. In some embodiments, the server may identify location, frequency, repeatability of text on the page data relative to other text on the page.

At step 584, the server analyzes the text from the working set of page data to determine if there is any type and form of matching to any campaigns. In some embodiments, the server performs any type and form of semantic matching to match keywords on the page semantically to concepts, meanings, categories, subject matter and/or keywords of campaigns. In some embodiments, the server performs a phonetic match between keywords on the page to keywords of campaigns. In some embodiments, the server performs a spelling match between keywords on the page to keywords of campaigns. In some embodiments, the server performs content filtering on text, words, and portions of content around the keywords on the page to determine a context for the keywords and match that context to campaigns. In some embodiments, the server performs content filtering on the page data to determine a category, a sub-category, a topic, subject matter or other information indicator and matches the same to any one or more campaigns.

In some embodiments, the server may generate a set of keyword from campaigns targeted towards the site of the page or publisher of the page. The server may generate a site keyword list. The keyword matcher of the server may match keywords from a keyword list, such as the site keyword list, against text of the page data to identify keywords in the page data. In some embodiments, the keyword matcher identifies multiple word phrase matches. In some embodiments, the keyword matcher identifies partial word phrases. In some embodiments, the keyword matcher identifies a number of times or the frequency for which a keyword is found in the page data. In some embodiments, the keyword matcher identifies the location of the keyword in the page data, and in further embodiments, relative to other keywords or boundaries of the page, such as top or bottom.

At step 586, the server performs any type and form ranking of keywords of the page data identified by the keyword matcher. The keyword ranker may rank all of the matching keywords. The keyword rank may rank a predetermined number of keywords. The keyword ranker may rank the keywords according to any one or more metrics. The keyword ranker may rank the keywords according to any one or more criteria. The keyword ranker may rank each keywords by applying a weight to a value assigned to the keyword. The keyword ranker may provide any multipliers to a valued or weighted value of the keyword to increase or decrease the ranking of the keyword. The keyword ranker may rank the keywords on any type and form of scale, which may be absolute or relative.

At step 588, the server matches the ranked keywords to keywords of one or more campaigns. The keyword matcher, ranker or campaign selection engine may compare the list of ranked keywords, or any portions thereof, to a list of keywords of one or more campaigns. In some embodiments, the server identifies those campaigns that are contenders to be a selected for the campaign for this page. In some embodiments, the server identifies those campaigns associated with or assigned to be a campaign targeted to site or publisher of the page. The server may match the ranked keywords against the identified campaigns. In some embodiments, the server may match the ranked keywords against all campaigns. In some embodiments, the server may change the ranking of the keywords based on results of matching the keywords from the campaigns.

At step 590, the campaign selection engine selects a predetermined number of matching keywords and their campaigns. In some embodiments, the campaign selection engine selects a predetermined number of top matching keywords and their campaigns. In some embodiments, the campaign selection engine selects a number of top matching keywords and their campaigns corresponding to a number of matching keywords on the page. For example, if there are five unique keywords on the page and each identified by a campaign, the server may select five campaigns. In some embodiments, the campaign selection engine may select one campaign for a plurality of corresponding matching keywords on the page.

In some embodiments, the campaign selection engine may filter out campaigns based on any type and form of filter rules. The campaign selection engine may rank campaigns according to any type and form of ranking. For example, the campaign selection engine may prioritize campaigns according to clients, volume, importance, spend, budget, historical campaign performance or any other desired criteria. The campaign selection engine may compare the ranked keywords to the ranked campaigns. The campaign selection engine may select any of the higher or highest ranked campaigns matching any of the higher or highest ranked keywords.

At step 592, the server sends to the agent the selected keywords and their campaigns. Responsive to the campaign selection engine, the server may send to the agent the list of keywords to augment or hook and their corresponding campaigns. In some embodiments, the server sends a predetermined number of additional keywords to augment or hook in case the agent cannot hook or augment any one or more keywords in the list of keywords. In some embodiments, the server sends an ordered list of keywords. The ordered list of keywords may identify a priority of augmentation or hooking to the agent.

The server may send any type and form of information to the agent on how to augment or hook a keyword, what type of augmentation to use and identifying the form and content of the augmentation. In some embodiments, the server sends to the agent publisher and campaign identifiers for the agent to obtain or identify the appropriate campaign for a keyword. In some embodiments, the server sends the agent an indication of the visual indicator to use for the hooked keyword (e.g., double underlined). In some embodiments, the server sends the agent the executable instructions by which the keyword is hooked or for replacing the text of the keyword with a hooked keyword.

In some embodiments, the server sends instructions for content, construction and/or display of the tooltip. In some embodiments, the server sends a set of executable instructions providing the tooltip and/or any portion thereof. In some embodiments, the server sends a set of executable instructions providing the augmented content and/or any portion thereof. In some embodiments, the server sends a set of executable instructions providing any embodiments of the augmented content, advertisements and/or tooltip of FIG. 5I. In some embodiments, the server sends content for the tooltip to provide the campaign assigned to the keyword. In some embodiments, the server sends one or more URLs referencing a campaign to be delivered via a web-site. For example, in some embodiments, the server sends one or more URLS to advertisements to be delivered for the campaign. In some embodiments, the server sends one or more scripts to agent to provide any of the above embodiments.

At step 594, the agent hooks the identified keywords on the page The agent may replace each keyword in the identified list of keywords from the server with instructions or code to hook the keyword. The agent may have hyperlink or link the keyword to a set of code or executable instructions to display the tooltip, augmented content or any embodiments of FIG. 5J. The agent may use modify the keyword to provide any type and form of visual indicator (e.g., double underlined or icon) to indicate the keyword is user interactive, hyperlinked or linked or otherwise hooked. The agent may modify the page to change the text to a liked or hooked text and to link or associated any forms of augmented content of FIG. 5J to be displayed or provided via user interaction with the hooked text. The agent may modify the page or instrument the keyword to detect when a user interacts with the keyword in a certain way. The agent may include one or more event based functions that are trigged responsive to predetermined user interactions. For example, the agent may modify the page or instrument the keyword to detect when a user mouses over the keyword, clicks on the keyword, right clicks on the keyword or left clicks on the keyword or otherwise selects any predetermined set of keystrokes or sequence of keystrokes.

At step 596, the agent detects user interaction such as mouse over or click of a keyword on the page and displays augmented content, such as a tooltip. The agent may detect when a mouse is over the keyword at any time. The agent may detect when a user has the cursor over the keyword. The agent may detect when a user has put focus on the keyword. The agent may detect when a mouse is over the keyword for a predetermined period of time. The agent may detect when a user highlights or selects a keyword. The agent may detect when the user left or right clicks on the keyword. The agent may detect when a user double clicks the keyword. The agent may detect when a user has put focus on the keyword and hit entered. The agent may detect any set of keystrokes with respect to the keyword.

Responsive to the detection, the agent may display augmented content, for example, any of the forms depicted in FIG. 5I. In some embodiments, responsive to detecting a mouse over of the keyword, the agent displays a tooltip delivering a campaign assigned to the keyword. In some embodiments, responsive to detecting a click on the keyword, the agent displays a tooltip delivering a campaign assigned to the keyword. Responsive to detection of the predetermined user interaction, the agent may display augmented content of any form, such as related videos, in predetermined areas or space on the page. Responsive to detection of the predetermined user interaction, the agent may display advertisements of any form, in predetermined areas or space on the page.

In some embodiments, the tooltip may remain displayed until the mouse is moved off of the keyword. In some embodiments, the tooltip may remain displayed until the mouse is moved off of the keyword for a predetermined time. In some embodiments, the tooltip may remain displayed until the mouse is moved off of the keyword until the user closes or exists the tooltip. In some embodiments, if the user clicks on the keyword after the mouse over, the tooltip remains displayed until the user closers or exits the tooltip. In some embodiments, any augmented content may change as the user moves the focus or mouse over to another keyword. For example, moving the mouse to a second keyword may cause a different advertisement to appear in a banner ad or may cause a new tooltip to be displayed or content of the current displayed tooltip to change.

The agent and may perform all or any of the steps of the method of FIG. 5K in real-time upon receipt and/or loading of the page. For example, the agent and the server may be designed and constructed to perform embodiments of steps 580 through 594 within a predetermined time while the page is being loaded by the browser. In some embodiments, the agent and the server may perform embodiments of steps 580 through 594 in milliseconds, for example within in 100, 200, 300, 400, 500, 600, 700, 800 or 900 milliseconds or within 10, 20, 30, 40, 50, 60, 70, 80 or 90 milliseconds, or within 1, 2, 3, 4, 5, 6, 7, 8 or 9 milliseconds or 0.1, 0.2, 0.3, 0.4, 0.5, 0.6, 0.7, 0.8 or 0.9 milliseconds. The agent and the server may be designed and constructed to perform embodiments of steps 580 through 594 while the page is loading and before the page is completely loaded. The agent and the server may be designed and constructed to perform embodiments of steps 580 through 594 in the background while the pages is being loaded and/or the user is browsing the loaded page.

D. Systems and Methods of Determining Safeness for Displaying Content of a Publisher

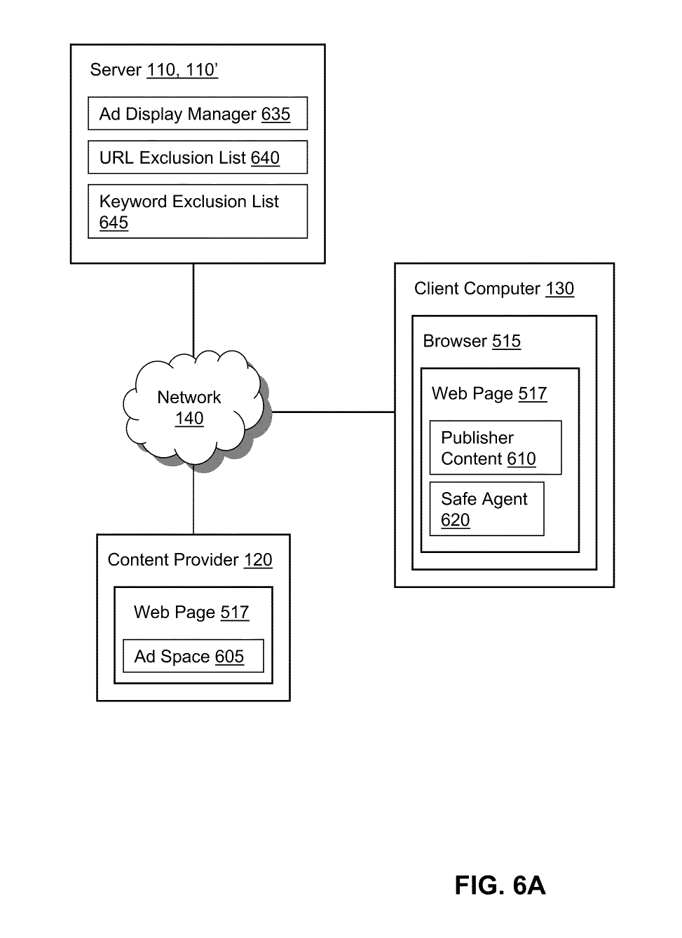

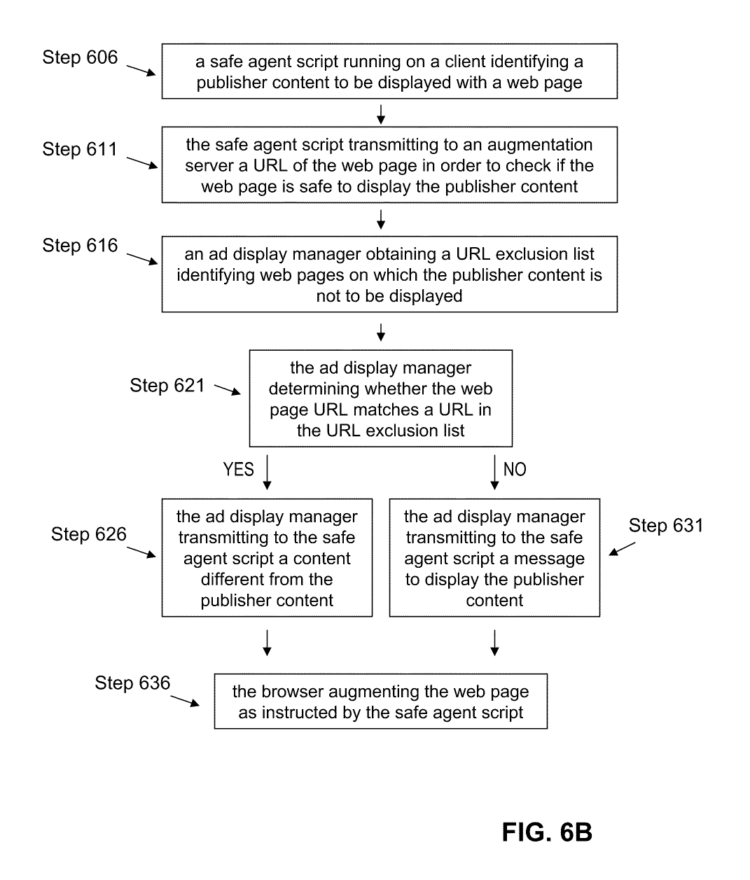

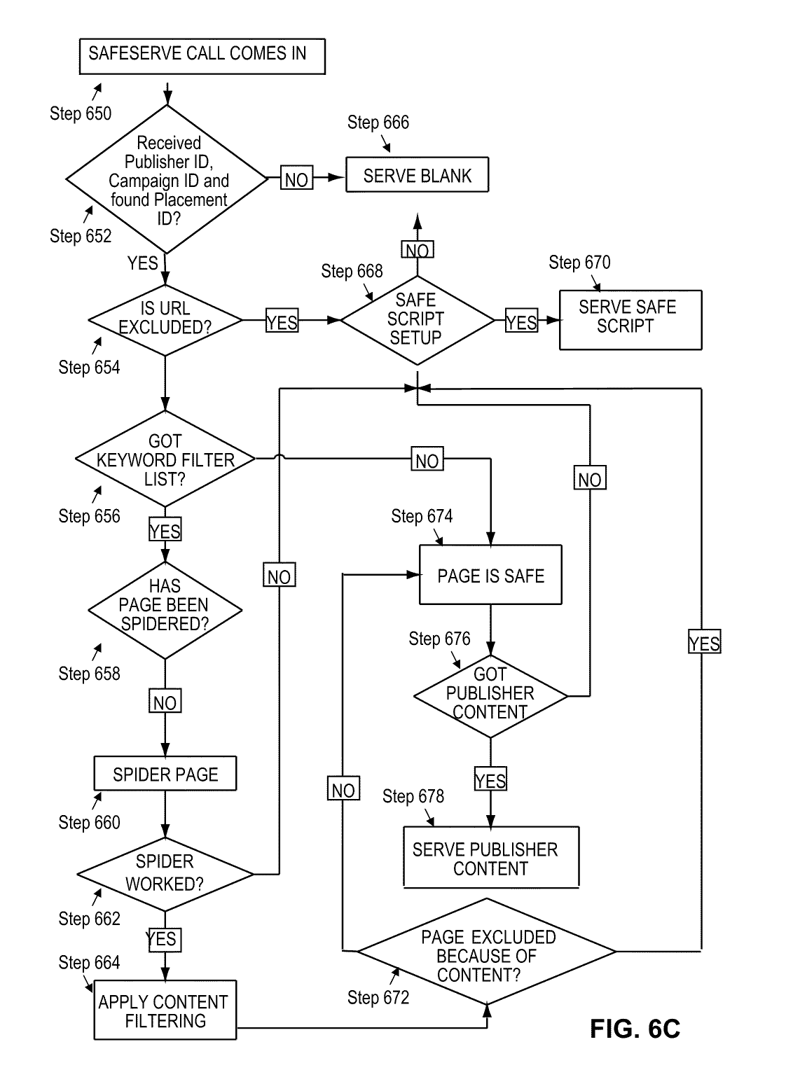

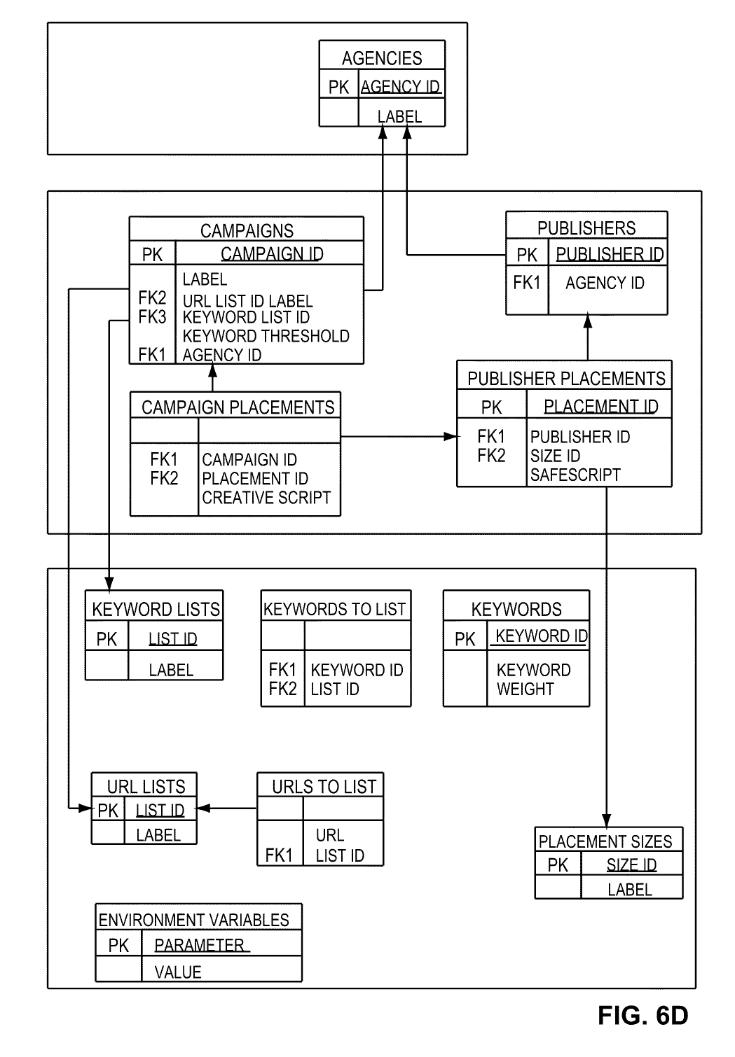

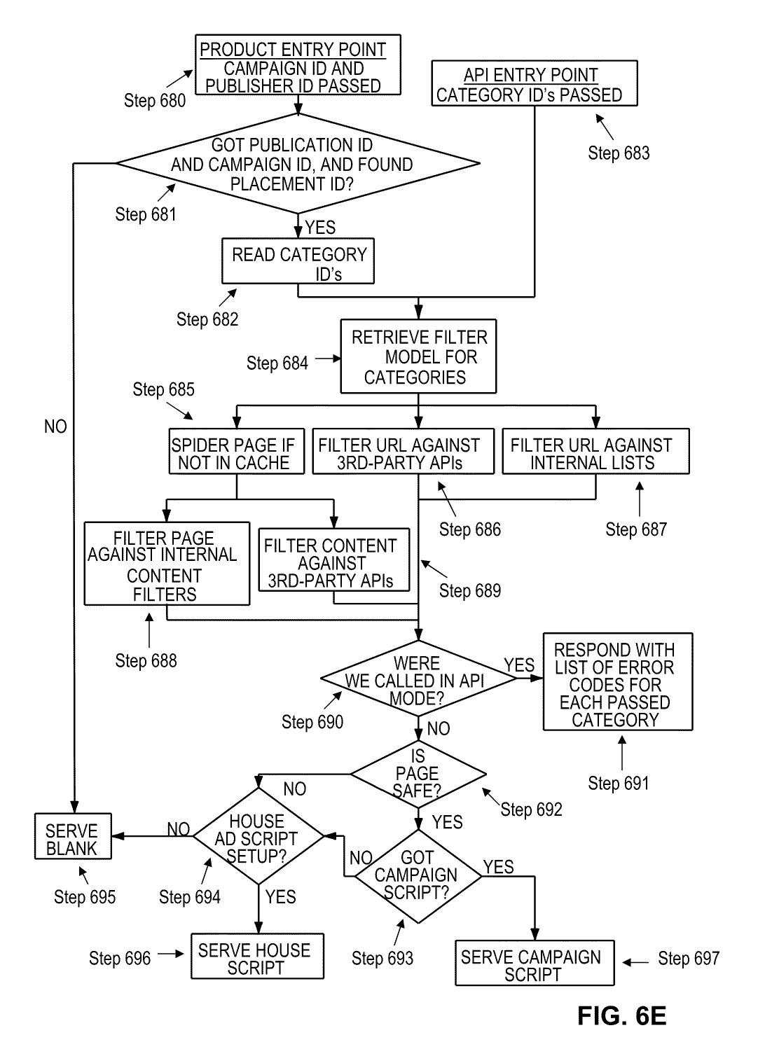

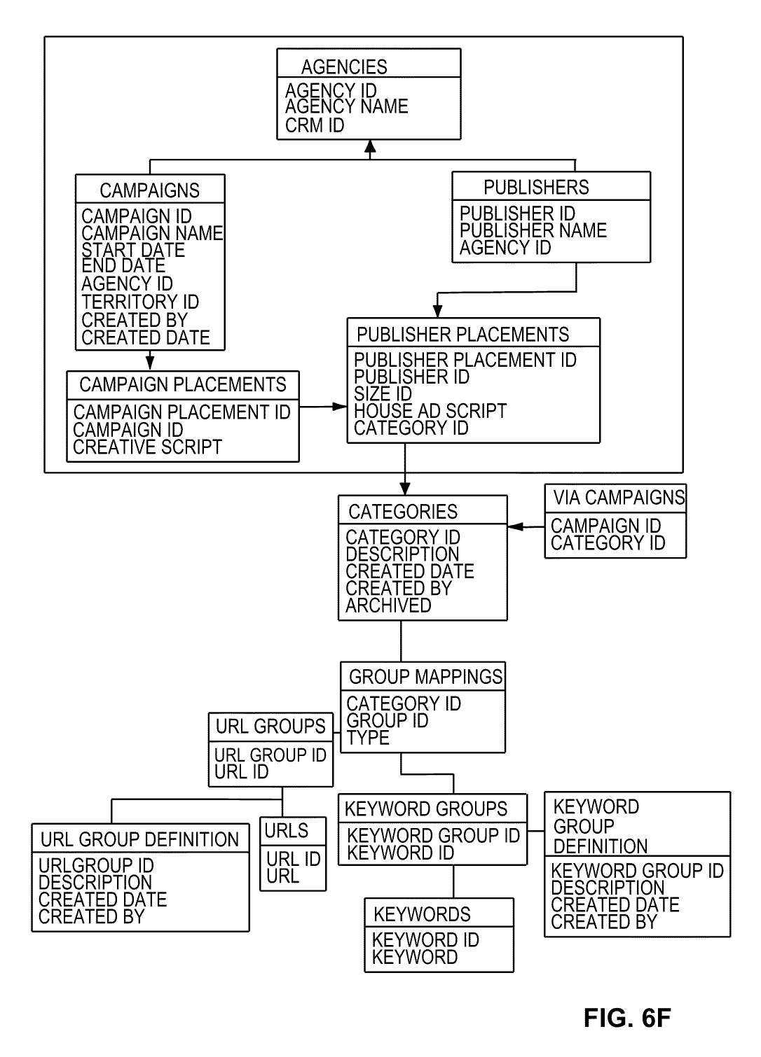

Referring now to FIG. 6A, an embodiment of a system for determining whether a web page loaded by a client is safe for displaying content from a publisher is illustrated. In brief overview, a browser 517 operating on a client computer 130 may load a web page 517 from a content provider 120. Web page 517 may include an ad space 605 for displaying content, such as an advertisement. In addition to the browser 515, client computer 130 may include publisher content 610 and safe agent 620. Augmentation server 110 may be in communication with client computer 130 via network 140. Augmentation server 110 may include an ad display manager (ADM) 635, a URL exclusion list 640 and a keyword exclusion list 645.

In brief overview, FIG. 6A describes an embodiment of a system for determining whether content of a web page being loaded by a client is safe for displaying content from a publisher. A user surfing the world wide web via browser 515 operating on client computer 130 may access web page 517 served by content provider 120. Web page 517 may include one or more ad spaces 605 which may provide space available for displaying advertisements. Client computer 130 may include publisher content 610 which may include any advertisements, presentations, announcements, fliers or commercials to be displayed within ad space 605 of web page 517.

Ad display manager 635 of augmentation server 110, controlling the display of publisher content 610, may check the content for each web page 517 on which the publisher content 610 is displayed in order to ensure that the web pages 517 displaying publisher content 610 are suitable and/or safe for displaying publisher content 610. For example, a client or a publisher may request not to display publisher content 610 on web pages 517 that are not safe, compatible or suitable to display publisher content 610. In such embodiments, a safe agent 620 which may be loaded by browser 515 along with publisher content 610, may send to augmentation server 110 information about web page 517, such as a uniform resource locator (URL) of web page 517 or one or more words or keywords of the web page 517. Ad display manager 635 may use the information received from safe agent 620 to check whether the web page 517 is safe or suitable for displaying publisher content 610. In some embodiments, ad display manager 635 matches the URLs received from safe agent 620 with URLs of a URL exclusion list 640. URL exclusion list 640 may include any number of URLs of any number of web pages or web sites for which publisher content 610 is not to be displayed. Similarly, ad display manager 635 may match and/or compare text, words or keywords from web page 517 against words or entries of a keyword exclusion list 645 in order to determine if the content or text of web page 517 is unsuitable or unsafe for displaying publisher content 610. Augmentation server 110 may transmit to safe agent 620 a response. In some embodiments, the response the response instruct the safe agent 620 to display or to permit displaying the publisher content 610 within ad space 605 of web page 517. In some embodiments, the response includes content that is different from publisher content 610 to display within web page 517 instead of the publisher content 610. In some embodiments, the response includes instruction to display blank content within ad space 605 instead of publisher content 610.

In further overview of FIG. 6A, web page 517, in addition to aforementioned embodiments, may include any functionality for displaying an advertisement, such as publisher content 630. In some embodiments, web page 517 includes functionality to display content using hypertext markup language, extensible markup language, java, javascript or any other language, instruction or script used in web pages. Web page 517 may include a window, a section or a portion dedicated to displaying publisher content 610. In some embodiments, web page 517 comprises functionality for displaying advertisements or postings from third parties. Advertisements, such as for example publisher content 610, may include information or content about products, events and/or services offered by individuals, enterprises, government, companies or any type and form of organizations. Web page 517 may include any number of ad spaces 605 for providing space or arrangement within web page 517 in which one or more advertisements or publisher contents 610 may be displayed. Web page 517 may be stored on any number of web servers, such as content providers 120 and may be accessed and/or loaded by any web browser, such as browser 515.

Ad space 605 may include any component of web page 517 providing a space or an arrangement within a web page 517 in which an advertisement, such as publisher content 610, may be displayed. Ad space 605 may include functionality for enabling displaying of publisher content 610, such as a script, an algorithm, an object, a program, an executable code or a link. Ad space 605 may include a web page banner. Ad space 605 may include a space within a web page or besides a web page for displaying a banner or an advertisement. Ad space 605 may include any type and form of overlays, rollovers or other ad types or user interface elements that appear over or across a web page. Ad space 605 may be located anywhere within, next to, above, under, over or across web page 517 and may comprise any shape and/or format.

Ad space 605 may include links or hyperlinks to other web sites which may be used to load the functionality or content to be displayed within ad space 605. In some embodiments, ad space 605 is a part of web page 517 and is loaded with web page 517. In other embodiments, ad space 605 is external to web page 517 and is loaded separately from web page 517. Ad space 605 may include algorithms, scripts and/or programs which may run within any computing space on the client computer 130, such as a browser 515. Ad space 605 may include interactive functionality enabling the ad space 605 to be modified, controlled and/or loaded with publisher content 610. In some embodiments, ad space 605 includes functionality to be accessed, controlled and/or edited by safe script 635. Ad space 605 may be modified to include and display any number publisher contents 610 of any format, style or content. Ad space 605 may include functionality for switching the publisher contents 610 displayed in response to an internal configuration or instructions from a safe agent 620 or browser 515. Ad space 605 may be modified, reshaped, split and/or combined with any other ad space 605 by safe agent 620 and/or browser 515 in accordance with preferences of safe agent 620 and/or browser 515.

In addition to aforementioned embodiments, browser 515 may include any functionality for loading and running a safe agent 620 and publisher contents 610. Browser 515 may include an application software for loading, running and using information from safe agents 620 to communicate with augmentation servers 110 and/or content providers 120. Browser 515 may include functionality for retrieving, accessing and loading information about publisher content 610 from safe agent 620 associated with publisher content 610. Browser 515 may enable, participate in or assist a safe agent 620 in communication with ad display manager 635. Browser 515 may enable, participate in or assist a safe agent 620 in displaying publisher content 610 within ad space 605 of web page 517. Browser 515 may include any functionality for loading, running, processing and/or displaying publisher content 610 in accordance with instructions provided by safe agent 620.

Publisher content 610 may include any type of content or information, such as any type and form of media. The publisher content may be displayed o a web page 517. Publisher content 610 may include a widget, an advertisement, a flyer, a notification, an announcement, a presentation, a video or an audio promotion or any other information pertaining to a product, service, information or announcement. Publisher content 610 may be provided by any type and form of publisher, such as a client company, enterprise, organization, individual, web site or an advertisement company or agency. In some embodiments, publisher content 610 includes an information about a product, event or a service. In further embodiments, publisher content 610 includes a graphical presentation, text, audio or video file, an HTML, XML or flash content or any other type and form of content displayable in a web page 517. Publisher content 610 may include a link or hyperlink to a web page of a publisher, enterprise or a company advertising a product or a service. In further embodiments, publisher content 610 includes graphics, such as logo of an enterprise or a company or a sign or logo of a product. Publisher content 610 may include any information a publisher may be interested in advertising to users accessing web pages 517 via world wide web.

Publisher content 610 may include source code, an algorithm, a function or a script. Publisher content may include calls for functions, files and/or documents. Publisher content 610 may include information for determining if web page 517 is safe for displaying or including publisher content 610. Publisher content 610 may include a safe agent 620 or functions and/or scripts for using safe agent 620. Publisher content 610 may comprise a placement ID identifying a place in which publisher content 610 is to be inserted or displayed. Publisher content 610 may further comprise campaign ID identifying an advertisement campaign. Publisher content 610 may further include publisher ID which may identify publisher content 610. In some embodiments, publisher ID identifies the publisher who is owner of publisher content 610 or whose product or service is advertised by publisher content 610.

Safe agent 620, also sometimes referred to as safe agent script 620 in some embodiments, may include any functionality, logic or operations for determining safeness of a web page 517 to display publisher content 610. Safe agent 620 may include any hardware, software executable on a device or a combination of hardware and software for determining whether or not web page 517 is safe for displaying publisher content 610. Safe agent 620 may include an application, a program, a script, a library, a process, a service, a take or any other type and form of executable instructions. Safe agent 620 may include a script or executable instructions loaded by a browser 515. In some embodiments, safe agent 620 includes a script or executable instructions executed by the client computer 130.

Safe agent 620 may comprise any number of instructions, logic, rules and/or policies for using information received from ad display manager 635 to determine whether or not to display publisher content 610 within web page 517. In some embodiments, safe agent 620 receives a response from ad display manager 635 and uses contents of the response to determine whether or not to instruct browser 515 to display publisher content 610 within web page 517. In further embodiments, safe agent 620 uses a set of instructions received from ad display manager 635 comprising determination whether or not web page 517 is safe for displaying publisher content 610. In some embodiments, safe agent 620 receives results from ADM 635 matching URLs of the web page 517 against URLs of the URL exclusion list 640. In other embodiments, safe agent 620 receives results from ADM 635 matching words, text, keywords or content of the web page 517 against entries in keyword exclusion list 645. Safe agent 620 may use the results received from ADM 635 to determine safeness of the web page 517. In some embodiments, if ADM 635 determines that URL of web page 517 matches an entry in URL exclusion list 635. Safe agent 620 may determine that web page 517 is not safe for displaying publisher content 610 in response to information from ADM 635 that a URL, a keyword, a string of text or content of web page 517 matches URL exclusion list 635 and/or keyword exclusion list 640. In some embodiments, safe agent 620 determines that web page 517 is not safe for displaying publisher content 610 in response to information from ADM 635 that a URL, a keyword, a string of text or content of web page 517 matches URL exclusion list 635 and/or keyword exclusion list 640. Safe agent 620 may include functionality to requesting from augmentation server 110 or ADM 635 a content that is different from publisher content 610, in response to determining that web page 517 is not safe to display publisher content 610.

Safe agent 620 may include functionality, logic or operations for extracting information from web page 517 and sending the extracted information to augmentation server 110. Safe agent 620 may include any embodiment of agent 520. In some embodiments, agent 520 includes safe agent 620. Safe agent 620 may include functionality for extracting information from web page 517 and sending this information to ad display manager 635. Safe agent 620 may include parse web page 517 or spider or index web page 517 and/or links of the web page 517. Safe agent 620 may acquire and/or copy a URL of web page 517 and/or URLs within web page 517. In some embodiments, safe agent 620 determines URLs of the links or hyperlinks within web page 517. Safe agent 620 may send URLs retrieved from web page 517 to augmentation server 110 and/or ad display manager 635 of augmentation server 110. Safe agent 620 may parse or retrieve text and one or more words or keywords of web page 517. Safe agent 620 may transmit the words or keywords parsed or retrieved from web page 517 to ad display manager 635. In some embodiments, safe agent 620 sends all of the text and/or content from web page 517 to ad display manager 635. Safe agent 620 may send any information associated with the web page 517 and/or ad spaces 605 within the web page 517 to ad display manager 635.

Safe agent 620 may include any functionality, logic or operations for instructing browser 515 whether or not to display publisher content 610 in web page 517. Safe agent 620 may include any set of instructions, logic, rules and/or policies for instructing browser 515 to display publisher content 610 within web page 517. In some embodiments, safe agent 620 includes functionality to prevent browser 515 from displaying publisher content 610 within web page 517. Safe agent 620 may provide instructions to instruct to display publisher content 610 or not to display publisher content 610 in response to a message or instruction received from ad display manager 635. Safe agent 620 may include a functionality for instructing browser 515 to include no content within ad space 605. In some embodiments, safe agent 620 instructs browser 515 to leave ad space 605 blank. Safe agent 620 may include any set of instructions to control displaying of any content in connection with a publisher corresponding to publisher content 610.

Safe agent 620 may include a script, code, function, program or a tag which may be embedded or included with publisher content 610. In some embodiments, safe agent 620 includes a tag or executable instructions, such as:

<script language=”javascript”>
(function( ){
var cid=123;
var pubid=456;
var url = ((top==self)?self.location.href:self.document.referrer);
var depth=(function( ){
var d=0, p=self;
while (p!=top)
{ d++;
p=p.parent;
} return d;
})( );
document.write(‘<scr’+’ipt language=”javascript’” +
‘src=”http://brandsafe.intellitxt.com/bs.jsp’ + ‘?cid=’+cid +
‘&pubid=’ + pubid + ‘&url=’ + encodeURIComponent(url) +
‘&d=’ + depth +
‘” ></scr’+’ ipt>’);
})( );</script>

In some embodiments, safe agent 620 includes a tag, or a script, may include content, such as:

<script language=”javascript”>
(function( ){
var cid=123;
var pubid=456;
document.write(‘<scr’+’ipt language=”javascript’” +
‘src=”http://brandsafe.intellitxt.com/bs.jsp’ + ‘?cid=’+cid + ‘&pubid=’ + pubid +
‘”></scr’+’ipt>’);
})( ); </script>

Ad display manager 635, also referred to ADM 635, may include any hardware, software executable on hardware or a combination of hardware and software for matching information corresponding to web page 517 with entries stored in URL exclusion list 640 or keyword exclusion list 645. ADM 635 may include any application, program, algorithm, script, programming code, executable, library, process, service task, rule, policy, logic and/or function for comparing or matching information corresponding to web page 517 with entries stored in an exclusion list. An exclusion list may include any list of data or information, such as a URL exclusion list 640 or a keyword exclusion list 640. In some embodiments, ADM 635 includes functionality for comparing or matching one or more URLs received from safe agent 620 with URL entries stored in URL exclusion list 640. ADM 635 may include functionality for comparing or matching string of characters, text, words, keywords and/or any portion of content of web page 517 with entries stored in keyword exclusion list 645. ADM 635 may include any functionality, logic or operations for spidering or indexing a web page, such as web page 517. ADM 635 may include a parser for parsing and analyzing a text of a web page 517. In some embodiments, ADM 635 includes a web crawler program or tool for indexing and/or spidering a web page 517. ADM 635 may include a storage for storing parsed, indexed and/or spidered web pages 517. ADM 635 may include any logic or function for communicating with safe agent 620. ADM 635 may include any functionality for transmitting to safe agent 620 instructions and/or results from analyzing web page 517 for safeness. The instructions may include results of the matches or comparisons made by matching or comparing URLs, text, words or keywords corresponding to web page 517 against entries in URL exclusion list 640 and/or keyword exclusion list 645.

ADM 635 may include any functionality for determining whether or not web page 517 is safe for displaying publisher content 610. In some embodiments, ADM 635 determines safeness of a web page 517 in conjunction with safe agent 620. In other embodiments, ADM 635 includes logic for determining whether web page 517 is safe for displaying publisher content 635. In further embodiments, ADM 635 includes functionality to provide safe agent 620 with information which can be used to determine whether or not web page 517 is safe for displaying publisher content 610. In some embodiments, ADM 635 includes functionality or logic to determine which content other than publisher content 610 is safe to display on web page 517. ADM 635 may include any logic or function for determining based on results of matching or comparison of URLs, text or words of web page 517 against URL exclusion list 640 and/or keyword exclusion list 645. In some embodiments, ADM 635 transmits information to safe agent 620 indicating that web page 517 is safe for displaying publisher content 610. In other embodiments, ADM 635 transmits information to agent 620 indicating that web page is not safe for displaying publisher content 610. In further embodiments, ADM 635 transmits to safe agent 620 content, such as publisher content 610 that is different from publisher content 610 on client computer 130. ADM 635 may send safe agent 620 a new publisher content 610 that corresponds to a same or a different publisher to display instead of publisher content 610 on client computer 130.

URL exclusion list 640 may include any hardware, software executable on hardware or a combination of hardware and software for storing any number of uniform resource locators (URLs) corresponding to any number of web pages, such as a web page 517. URL exclusion list 640 may comprise a list or a collection of URLs which may correspond to one or more web pages, such as web page 517. URL exclusion list 640 may comprise a database or a table of a database storing URLs. URL exclusion list 640 may include a black list of URLs that comprises URLs of web pages 517 that are considered banned, excluded or unsafe for displaying publisher content 610. In some embodiments, URL exclusion list 640 includes a white list of URLs comprising URLs of web pages 517 that are considered safe and/or desirable to include publisher content 610. In some embodiments, URL exclusion list 640 includes information other than URLs, such as for example information about text, words or keywords of web pages. For example, URL exclusion list 640 may include strings of text, words and/or keywords which are considered desirable or safe. Web pages 517 comprising such strings of text, words and/or keywords may be considered safe for including publisher content 610. Similarly, URL exclusion list 640 may include strings of text, words and/or keywords which are considered unsafe or undesirable and web pages 517 comprising these strings of text, words and/or keywords may be considered unsafe and undesirable for including publisher content 610. URL exclusion list 640 may be publisher content 610 specific or specific to publisher or client owning, sharing and/or corresponding to the products or services advertised by publisher content 610. URL exclusion list 640 may be identified by a publisher ID. In some embodiments, URL exclusion list 640 is identified by a campaign ID. In further embodiments, URL exclusion list 640 is identified by a placement ID.

Keyword exclusion list 645 may include any hardware, software executable on hardware or a combination of hardware and software for storing any number of entries comprising words and/or strings of characters, such any content corresponding to any web pages 517. Keyword exclusion list 645 may comprise a list words, sentences, terms, keywords or any selection of strings of characters which may correspond to one or more web pages 517. Keyword exclusion list 645 may include a database or a table of a database storing words, text, or keywords. Keyword exclusion list 645 may include a black list of words, text, keywords or content that are considered banned, excluded or unsafe for being displayed in the same web page 517 as publisher content 610. In some embodiments, keyword exclusion list 645 includes a white list of words, text, keywords or content that are considered safe and/or desirable to be displayed in a web page that also includes publisher content 610. In some embodiments, keyword exclusion list 645 URLs, meta tags or data tags.

In one example, keyword exclusion list 645 may include numerous entries of strings of text, words or any string of characters which are considered desirable or safe. Web pages 517 that include such safe or desirable text, words or strings of characters may be considered safe for including publisher content 610. As with URL exclusion lists 640, keyword exclusion lists 645 may be publisher content 610 specific or specific to the publisher whose products and/or services are advertised by publisher content 610. Keyword exclusion list 645 may be identified by a publisher ID. In some embodiments, keyword exclusion list 640 is identified by a campaign ID identifying a campaign of the publisher. In further embodiments, keyword exclusion list 640 is identified by a placement ID. A keyword exclusion list 645 and URL exclusion list 640 may be combined into a single list, a single table or a single data base. In some embodiments, URL exclusion lists 640 and keyword exclusion lists 645 are all combined into a compilation of information stored in a single storage location on augmentation server 110.

Referring now to FIG. 6B, an embodiment of steps of a method for determining whether a web page loaded by a client is safe for displaying a publisher's content is illustrated. At step 606, safe agent script 620 running on client 130 identifies publisher content 610 to be displayed with web page 517. At step 611, safe agent script 620 transmits to augmentation server 110 a URL of web page 517 to check if web page 517 is safe to display or include publisher content 610. At step 616, ad display manager 635 operating on augmentation server 110 obtains a URL exclusion list 640 identifying web pages on which publisher content 610 is not to be displayed. At step 621, ad display manager 635 determines if web page 517 URL matches a URL in the URL exclusion list 640. At step 626, in response to ad display manager 635 determining at step 621 that the URL of web page 517 matches a URL in URL exclusion list 640, ad display manager 635 transmits to safe agent script 620 a content different from publisher content 610. At step 631, in response to ad display manager 635 determining at step 621 that the URL of web page 517 does not match a URL in URL exclusion list 640, ad display manager 635 transmit to safe script agent 620 a message to display publisher content 630. At step 636, browser 515 augments web page 517 as instructed by safe agent script 620.

In further overview of FIG. 6B, at step 606 safe agent script 620 running on a client computer 130 identifies publisher content 610 to be displayed with web page 517. Safe agent 620 may be received by client computer 130 along with web page 517. In some embodiments, safe agent 620 is received by client computer 130 together with publisher content 610 or as a component of publisher content 610. Safe agent script 620 may run in browser 515 of client computer 130 or independently from browser 515. In some embodiments, safe agent script 620 runs or operates independently while communicating with browser 515. Safe agent script 620 may identify publisher content 610 by recognizing or identifying an identifier of publisher content 610. In some embodiments, safe agent script 620 identifies a publisher identifier, or a publisher ID, which may identify the publisher owning, providing or being advertised by publisher content 610. In some embodiments, publisher ID uniquely identifies publisher content 610. In further embodiments, safe agent script 620 identifies a campaign identifier, or a campaign ID, which identifies a campaign of a publisher. In yet further embodiments, safe agent script 620 identifies a placement identifier, or a placement ID, which may include a block of code identifying a place in which publisher content 610 is to be placed or displayed. Safe agent script 620 may identify via placement ID that publisher content 610 is to be displayed within ad space 605 of web page 517. Safe agent 620 may use information about publisher content 610, such as a cookie, URL or an IP address identifying a source of publisher content 610 to identify publisher content 610. Safe agent 620 may use a placement ID to identify that publisher content 610 is to be displayed within a certain ad impression or ad space of web page 517. In some embodiments, safe agent 620 identifies that publisher content 610 is to be placed within web page 517 by identifying specific instructions for placing publisher content within web page 517.

At step 611, safe agent script 620 transmits to augmentation server 110 any information about web page 517 in order to determine if web page 517 is safe or suitable to display or include publisher content 610. In some embodiments, safe agent 620 sends to ad display manager 635 of augmentation server 110 a URL of web page 517. In other embodiments, safe agent 620 sends to ad display manager 635 one or more words or strings of characters or text from web page 517. In further embodiments, safe agent 620 sends to ad display manager 635 a portion of the text or content of web page 517. In yet further embodiments, safe agent 620 sends to ad display manager 635 information about links and/or hyperlinks of web page 517, which may include URLs of web pages to which web page 517 is linked. Safe agent script 620 may send to ad display manager 635 an information about publisher content 610, such as for example a publisher ID, a campaign ID and/or a placement ID. Safe agent 620 may send to ad display manager 635 any combination of publisher ID, campaign ID and/or placement ID to be used by ad display manager 635 to identify a URL exclusion list 640 or a keyword exclusion list 645 that corresponds to publisher content 610.

At step 616, ADM 635 obtains an exclusion list, such as a URL exclusion list 640 or keyword exclusion list 645 which corresponds to publisher content 610. In some embodiments, ADM 635 uses publisher ID of publisher content 610 to identify and obtain URL exclusion list 640 corresponding to publisher content 610. In some embodiments, ADM 635 uses publisher ID of publisher content to identify and obtain keyword exclusion list 645 corresponding to publisher content 610. ADM 635 may identify and obtain URL exclusion list 640 and/or keyword exclusion list 645 corresponding to publisher content 610 using a campaign ID. In some embodiments, ADM 635 identifies and obtains URL exclusion list 640 and/or keyword exclusion list 645 corresponding to publisher content 610 using a placement ID of publisher content 610. ADM 635 may use any combination of publisher ID, placement ID and/or campaign ID to obtain URL exclusion list 640 corresponding to publisher content 610. ADM 635 may use any combination of publisher ID, placement ID and/or campaign ID to obtain keyword exclusion list 645 corresponding to publisher content 610.

At step 621, ADM 635 determines whether or not information about web page 517 received from safe agent 620 matches any entry in the exclusion list, such as URL exclusion list 640 or keyword exclusion list 645. In some embodiments, ADM 635 matches or compares a URL of web page 517 received from safe agent 620 with each URL entry in URL exclusion list 640. ADM 635 may match or compare a portion of the URL of web page 517 with any entry in URL exclusion list 640. ADM 635 may match or compare a portion of the URL of web page 517 with any entry in keyword exclusion list 645. In some embodiments, ADM 635 matches a word or a string of characters from web page 517 with each entry in keyword exclusion list 640. ADM 635 may parse, index or spider web page 517 to match each word from web page 517 against each entry of keyword exclusion list 645. ADM 635 may use a keyword threshold to determine if the number of words in web page 517 that match entries in keyword exclusion list 645 exceeds a threshold. The threshold may indicated the maximum number of words matching keyword exclusion list 645 that is allowed for a web page 517 to still display publisher content 610. At step 621, ADM 635 may make same or similar determinations as in step 674 of FIG. 6C or step 584 of FIG. 5K.

ADM 635 may apply a weight associated with matched keywords to each matching keyword. In such embodiments, a sum of weighted matching keywords may be compared against a keyword threshold. In some embodiments, if keyword threshold is exceeded, web page 517 is not safe for displaying publisher content. In other embodiments, if keyword threshold is exceeded, web page 517 is safe for displaying publisher content. In some embodiments, a keyword threshold may be used to determined if a sum of all weighted matching keywords exceeds a threshold for the sum of weighed matching keywords for web page 517. In some embodiments, ADM 635 matches a URL of web page 517 against each entry of URL exclusion list 640. In further embodiments, ADM 635 matches each link or hyperlink portion of URL against entries of URL exclusion list 640. ADM 635 may determine that web page 517 includes a URL, a word, a keyword and/or content that matches one or more entries in any exclusion of the exclusion lists. ADM 635 may determine that web page 517 is not safe or suitable for displaying publisher 610 content in response to the determination that any URL associated with the web page matches an entry in any exclusion list. In further embodiments, ADM 635 determines that web page 517 is not safe for displaying publisher 610 content in response to the determination that a sum of weighted words of web page 517 exceeds a predetermined threshold. Similarly, ADM 635 may determine that web page 517 is safe based on a match of URL of web page 517 against URL entries in URL exclusion list 640. In some embodiments, ADM 635 determines that web page 517 is safe for displaying publisher 610 content in response to the determination that a sum of weighted words of web page 517 exceeds a predetermined threshold.

At step 626, in response to ADM 635 determining that the information corresponding to web page 517 matches an entry in an exclusion list, ADM 635 transmits to safe agent script 620 a content different from publisher content 610. ADM 635 may further transmit an instruction to display the content different from publisher content 610 instead of displaying publisher content 610. In some embodiments, ADM 635 determines that URL of web page 517 matches a URL entry in URL exclusion list 640. In such instances, ADM 635 may in response to this determination, transmit to safe agent 620 a content different from publisher content 610. In some embodiments, in response to determining that URL of web page 517 matches a URL entry in URL exclusion list 650, ADM 635 transmit to safe agent 620 an instruction to display publisher 610 within web page 517. ADM 635 may determine that a word, a keyword or a string of characters of web page 517 matches an entry in keyword exclusion list 645. In such instances, ADM 635 may in response to this determination, transmit to safe agent 620 a content different from publisher content 610. ADM 635 may also transmit to safe agent 620 an instruction to display publisher 610 within web page 517 in response to determining that the word, the keyword or the string of characters of web page 517 matches an entry in keyword exclusion list 645. ADM 635 may transmit to safe agent script 620 a content different from publisher content 610, such as for example a second publisher content 610 which may be from the same publisher as publisher content 610. In some embodiments, the second publisher content 610 is content from a different publisher, a different client or an enterprise. In some embodiments, ADM 635 transmits to safe agent 620 an instruction not to include any publisher content 610 in web page 517. ADM 635 may instruct safe agent 620 to leave ad space 605 within web page 517 blank.

At step 631, in response to ADM 635 determining that the information corresponding to web page 517 does not match any entry in an exclusion list, ADM 635 transmits to safe agent script 620 a message to display publisher content 610 within web page 517. ADM 635 may in response to this determination transmit to safe agent script 620 a content different from publisher content 610. In some embodiments, ADM 635 determines that URL of web page 517 does not match a URL entry in URL exclusion list 640. In response to determining that the URL of web page 517 does not match any URL in URL exclusion list 640, ADM 635 may transmit to safe agent 620 an instruction to display publisher content 610 with web page 517. In some embodiments, in response to determining that the URL of web page 517 does not match any URL in URL exclusion list 640, ADM 635 transmits to safe agent 620 a content different from publisher content 610. ADM 635 may determine that a word, a keyword or a string of characters of web page 517 does not match any entries in keyword exclusion list 645. In such instances, ADM 635 may in response to this determination, transmit to safe agent 620 an instruction to display publisher content 610 within web page 610. In some embodiments, in response to this determination, ADM 635 transmits to safe agent 620 a content different from publisher content 610 to display within web page 517. ADM 635 may transmit to safe agent 620 any message or instruction comprising placement ID that identifies a place within web page 517 in which publisher content 610 is going to be displayed.

At step 636, browser 515 augments web page 517 to display content responsive to safe agent script 630. In some embodiments, safe agent 620 instructs browser 515 to augment web page 517 to include publisher content 610 within web page 517. In some embodiments, safe agents 620 takes no further action and allows the publisher's content to be displayed as intended. In still further embodiments, browser 515 displays the content different from publisher content 610. In yet further embodiments, browser 515 displays the content different from publisher content 610 instead of displaying publisher content 610. In still further embodiments, browser 515 augments web page 517 to include a blank link, a blank line or a blank space instead of displaying publisher content 610. In yet further embodiments, browser 515 receives instructions from safe agent 620 to include publisher content 610 within ad space 605. Browser 515 may include content different from publisher content within ad space 605. In some embodiments, browser 515 may include, modify or edit publisher content 610 to fit within ad space 605. Browser 515 may augment web page 517 to display any content responsive to the safe agent 620.

Referring now to FIG. 6C, an example of an embodiment of steps for determining that content of a web page is content safe for delivering content from a publisher is depicted. A publisher may deliver to a third party ad network an advertisement, such as publisher content 610. A publisher may wish to choose on which web pages 517 publisher content 610 may be displayed. However, as a third party ad network might not provide such control to the publisher, publisher content 610 may include safe agent 620 for determining safeness of web pages 517 displaying publisher content 610. Publisher content 610 may be provided by any publisher, such as an enterprise, a company, a website, an ad exchange network or any provider of advertisement content. Publisher content 610 may be designed or modified to include a safe agent 620. Publisher content 610 may be distributed to a third party ad network for distributing on various web pages 517 via the world wide web. Third party ad networks may not include features to provide the determine safeness of web pages 517. Safe agent 620 may be deployed along with publisher content 610 to enable checking of safeness of web pages 517 despite third party ad network's lack of web page safeness monitoring features. As such, publisher content 610 may be distributed safely regardless if the ad network provides safeness features to publisher's wishing to control on which pages to include publisher content 610 and from which pages to exclude publisher content 610. In this example, a user on client 130 surfing the web using browser 515 accesses a web page 517. The user's browser 515 may load web page 517 and also load publisher content 610 along with safe agent 620. As web page 517 loads in browser 515, safe agent 620 may send a message, such as a function or an API call to augmentation server 110, 110′.

At step 650, a function or API call, referred to as a safeserver call, may be received by server 110, 110′ from safe agent script 620 at client 130. At step 652, a determination may be made to identify whether or not publisher ID and campaign ID have been received and whether or not placement ID has been found. At step 654, a determination of whether or not URL is included in the transmission may be made. At step 656, a determination may be made regarding whether or not a keyword filter list, such as keyword exclusion list 645 may be retrieved. At step 658, a determination may be made regarding whether or not web page 517 has been spidered. At step 660, if web page 517 has not been spidered previously, web page 517 may be spidered. At step 662 a determination may be made whether or not spidering procedure has succeeded. At step 664, keyword filtering may be applied. At step 666, an in instruction may be generated to serve blank content instead of publisher content 610. At step 668, safe agent script 668, or a transmission for safe agent script 620, may be set up. At step 670, safe agent script 670 may be served. At step 672, a determination may be made whether or not web page 517 is excluded from displaying publisher content 610 because of keywords included in web page 517. At step 674, a determination may be made whether or not web page 517 is safe. At step 676, a determination may be made weather or not publisher content is present or available. At step 678, publisher content 610 may be served.

In further overview of FIG. 6C, at step 650 augmentation server 110 may receive from safe agent script 620 a message corresponding to publisher content 610. The message may include a call, such as an API call. In some embodiments, message includes a safeserver or safeserv call to ADM 635. Safesery call may include instructions for initiating the process of determining, by ADM 635, whether or not web page is safe for displaying publisher content 610. In some embodiments, safeserv call includes instructions for initiating determining, by ADM 635, whether or not content of web page 517, such as words or URLs of web page 517, matches any entries in the exclusion lists stored on augmentation server 110.

At step 652, ADM 635 determines if publisher ID and campaign ID are received. In some embodiments, ADM 635 determines if placement ID for the publisher content 610 is found. In some embodiments, placement ID may be received. In other embodiments, placement ID may be determined by ADM 635 or any other component of augmentation server 110. Publisher ID and campaign ID may identify a particular publisher content 610 to be displayed in web page 517. Placement ID may identify a location in which publisher content 610 may be displayed, such as for example ad space 605 within web page 517.

At step 654, responsive to determination at step 652 that publisher ID, campaign ID and placement ID are obtained and/or received, ADM 635 determines if the URL of web page 517 is excluded. ADM 635 may initiate a procedure for determining if URL of web page 517 is found or entered in URL exclusion list 640. URL exclusion may be determined by finding campaign.URLListID based on campaign ID. Campaign.URLListID may identify the URL exclusion list 640 for a particular campaign. URL entries from this particular URL exclusion list 640 may be matched against URL of web page 517, and if any match is found, a determination may be made that this web page 517 will not include publisher content 610.

At step 656, ADM 635 determines if keyword exclusion list 645, which may also be referred to as keyword filter list, is present. ADM 635 may determine if publisher content 610 specific keyword filter list is present or stored on augmentation server 110. Keyword exclusion may be determined by finding Campaign.KeywordListID which may identify a keyword exclusion list 645 for a particular campaign.

At step 658, ADM 635 determines if web page 517 has been spidered or indexed. In some embodiments, ADM 635 determines if web page 517 underwent the process of indexing by a web crawler tool from a server, such as augmentation server 110. In some embodiments, ADM 635 determines that web page 517 has been indexed. In other embodiments, ADM 635 determines web page 517 has not been indexed.

At step 660, ADM 635 indexes web page 517 responsive to determination at step 658 that web page 517 was not spidered. ADM 635 may initiate a process of spidering web page 517. In some embodiments, ADM 635 initiates the process of indexing the web site. In further embodiments, ADM 635 parses the text of the web page 517 in order to index web page 517. In further embodiments, ADM 635 gathers and parses links and/or URLs comprised within web page 517 in order to properly index the site.

At step 662, ADM 635 determines if spidering of web page 517 has worked, or has been successfully completed. In some embodiments, if spidering or indexing of web page 517 is successful, meta keywords may be applied to contents of the web page, such as the text. IMG alt tags may be included for images of web page 517. Contents of the spidered web page 517 may be stored in a memory.

At step 664, ADM 635 applies content filtering of the spidered web page 517. In some embodiments, ADM 635 applies keyword filtering to the contents of the spidered web page 517. Keyword filtering may include any type of filtering of any portion of content of the web page 517, including words, text, links, tags, commands, instructions, links, URLs and any other portion of web page 517. In some embodiments, AMD 635 determines if words, strings of characters and/or keywords of web page 517 match any entries in keyword exclusion list 645. Keyword filtering may be applied by matching content, title and meta keywords of web page 517 against entries in keyword exclusion list 645. For each keyword that matches, keyword weights associated with matching keywords may be summed up. If a threshold is reached for the weight of matching keywords, web page 517 may be determined to be unsafe. In some embodiments, campaigns.keywordthreshold may indicate the keyword threshold which should not be reached for safe pages for total content of web page 517. If web page 517 keywords matching entries of keyword exclusion list 645 after all of the adjustments due to weights of keywords do not exceed the threshold, web page 517 may be determined to be safe. In white list scenarios, web page 517 may be determined to be safe in response to keywords threshold being exceeded.

At step 664, ADM 635 may analyze text to determine if there is any type and form of matching to any campaigns. ADM 635 may perform any type and form of semantic matching to match keywords on the page semantically to concepts, meanings, categories, subject matter and/or keywords of campaigns. In some embodiments, ADM 635 performs a phonetic match between keywords on the page to keywords of campaigns. In some embodiments, ADM 635 performs a spelling match between keywords on the page to keywords of campaigns. In some embodiments, ADM 635 performs content filtering on text, words, and portions of content around the keywords on the page to determine a context for the keywords and match that context to campaigns. In some embodiments, ADM 635 performs content filtering on the page data to determine a category, a sub-category, a topic, subject matter or other information indicator and matches the same to any one or more campaigns. ADM 635 may generate a set of keyword from campaigns targeted towards the site of the page or publisher of the page. The server may generate a site keyword list. The keyword matcher of the server may match keywords from a keyword list, such as the site keyword list, against text of the page data to identify keywords in the page data. In some embodiments, the keyword matcher identifies multiple word phrase matches. In some embodiments, the keyword matcher identifies partial word phrases. In some embodiments, the keyword matcher identifies a number of times or the frequency for which a keyword is found in the page data. In some embodiments, the keyword matcher identifies the location of the keyword in the page data, and in further embodiments, relative to other keywords or boundaries of the page, such as top or bottom.

At step 666, responsive to determination at step 652 that publisher ID, campaign ID and/or placement ID are not obtained and/or received, ADM 635 serves blank space, blank content or a blank link instead of publisher content 610. In some embodiments, responsive to determining that any of campaign ID, publisher ID and/or placement ID is not received and/or obtained at step 652, ADM 635 serves or sends a blank content to web page 517 instead of the publisher content 610. In some embodiments, AMD 635 sends instruction to safe agent script 620 to serve or display blank or empty content or link instead of publisher content 610. In further embodiments, ADM 635 sends blank content or blank link to safe agent 620 to display.

At step 668, responsive to determining that URL is excluded at step 654, ADM 635 sets up safe agent 620, which may also be referred to as safe script. In some embodiments, responsive to determining at step 654 that URL matches an entry in URL exclusion list 640, ADM 635 determines which content to display in web page 517 instead of publisher content 610. In further embodiments, AMD 635 determines a new advertisement content, such as a video file, audio file or a graphical content to be sent to safe agent 620 to be displayed in web page 517.

At step 670, responsive to setting up safe agent script 620 at step 668, ADM 635 serves safe agent script 620 or sends a message to safe agent script 620. In some embodiments, ADM 635 serves safe agent script 620 by sending the content or advertisement determined to be sent to safe agent 620 at step 668.

At step 672, ADM 635 may determine if web page 517 is to be excluded from displaying publisher content 610 because of the content of the web page 517. ADM 635 may make a determination to exclude web page 517 because of text, words, commands, instructions, scripts, strings of characters or keywords or any other content of the web page 517. ADM 635 may determine if publisher content 610 is to be excluded from web page 517 responsive to keyword filtering or content filtering applied at step 664.

At step 674, responsive to determining that web page 517 is not to be excluded because of keywords at step 672, ADM 635 determines that web page 517 is safe for publishing publisher content 610. In some embodiments, responsive to determining at step 656 that keyword filter list, such as keyword exclusion list 645 is not included, ADM 635 determines that web page 517 is safe for displaying publisher content 610. In further embodiments, ADM 635 determines that web page 517 is safe responsive to determination at step 654 that URL does not match any entries at URL exclusion list 640 and a determination at step 672 that page is not excluded because of keywords at keyword exclusion list 645.

At step 676, ADM 635 determines if publisher content 610 is present or available. In some embodiments, ADM 635 sends publisher content to safe agent script 620. In further embodiments, if safe agent 620 already includes publisher content 610, ADM 635 sends a message to safe agent 610 to determine if publisher content 610 at safe agent 620 is up to date.

At step 678, ADM 635 serves publisher content 610 to safe agent 620. In some embodiments, ADM 635 sends most up to date publisher content 610 to safe agent 620 to display within web page 517. In other embodiments, ADM 635 sends to safe agent 620 a message to go ahead and display publisher content 610 already present at client computer 130 within web page 517.

By following these steps, the systems described herein may check safeness of any web page 517 prior to displaying publisher content 610. As web page 517 may be loaded by any client 130 via any third party ad network, safeness of web pages 517 may still be checked and maintained for any publisher content 610 regardless if the third party ad network lacks web page 517 safeness features. As safe agent 620 of publisher content 610 may initiate web page safeness checking process by ADM 635 regardless of the ad network via which publisher content 610 has been provided, safeness of web pages 517 may still be checked prior to displaying publisher content 610.

Referring now to FIG. 6D, an embodiment of a database for storing information pertaining to publisher contents 610 at augmentation server 110 is displayed. Information may be organized in one or more tables, such as agencies table, campaign table, publishers table, campaign placements table and publisher placements table.

In further overview of FIG. 6D, tables may include any information or data regarding the processes described herein, including the agencies, campaigns, keywords, URLs, publisher contents, keyword exclusion lists 645 and URL exclusion lists 640. Agencies table may include any information about agencies providing the advertisement content. Information may include agency identifiers or IDs and labels. A campaign table may include information about one or more advertising campaigns. Campaign table may include a campaign ID, a label, a URL list label ID or a URL exclusion list ID, a keyword list ID or a keyword exclusion list ID. Campaign table may also include a keyword threshold for indicating what is the largest permissible number of keywords in a web page 517 matching entries in a keyword exclusion list 645 entries that may still publish publisher content 610. For example, keyword threshold may be 10, which may indicate that up to no more than 10 words, strings of characters or keywords in web page 517 may be encountered in web page 517 for web page 517 to still be acceptable for publishing publisher content 610. In some embodiments, a keyword entry may have a weight associated to be used to indicate if the keyword is more unacceptable than other keywords. Campaign table may also include agency ID.

Other tables, such as a publishers table may include publisher IDs and agency IDs. Campaign placements table may include campaign IDs, placement IDs and information about creative scripts, such as safe agent 620 scripts. Publisher placements table may include placement ID, publisher ID, size ID and safescript information about safe agent 620. Keyword lists, such as keyword exclusion list 645 may include list IDs and labels. Keywords to list may be comprised within keyword exclusion list 645 or outside of keyword exclusion list 645 in a separate storage. Keywords to list may include keyword IDs and list IDs. Keyword IDs may identify keywords, while list IDs may identify in which keyword exclusion lists 645 a particular keyword is included. Keywords table may include keyword IDs, keywords and weights assigned for each keywords. Weights may signify that some keywords have greater impact on safeness of web page 517 than other keywords. URL lists may include list IDs and labels. URLs to list may include URL entries and list IDs which may identify URL exclusion lists 640 in which URL entries may be included. Placement sizes table may include size ID and label. Environment variables may include parameters and values.

Campaign and publisher data may be different for each customer or enterprise having an advertisement campaign. Publisher data may indicate which placements each campaign or agency has available. URL exclusion lists 640 and keyword exclusion lists 645 may be shared among multiple agencies, enterprises and clients.

As presented in an example illustrated by FIG. 6E, safeness of a web page 517 may be determined using third party APIs. In some embodiments, third party APIs are be used to determine safeness of web page 517 in a manner that is similar to the way URL exclusion lists 640 and keyword exclusion lists 645. The process of determining safeness of the web pages may be initiated by APIs or API calls from third party publishers, such as the third party ad exchanges, agencies, enterprises or users. A third party publisher may transmit to ADM 635 APIs which may include content, entries or information used to determine safeness of web page 517. The third party APIs may include contents, words, URLs, meta information or any web page 517 related information used to determine safeness of web page 517. The third party APIs may include any functionality or information comprised by URL exclusion list 640 and/or keyword exclusion list 645. The third party APIs may be specific to a third party publisher, such as the third party ad exchange, or specific to a campaign or an advertisement, such as the publisher content 610 which may be provided by the third party publisher. ADM 635 may use the third party APIs to match any information received from the third party publisher with any information, entry or content of the third party APIs. ADM 635 may determine safeness of web page 517 for publishing a publisher content 610 of the third party publisher (or the third party ad exchange), responsive to one or more matches found in the third party APIs. As with URL exclusion lists 640 and keyword exclusion lists 645, ADM 635 may determine safeness of web page 517 using weights and thresholds for any matches found in the content of the third party APIs.

Referring now to FIG. 6E, an embodiment of steps for determining safeness of web page 517 by filtering web page 517 content using URL exclusion lists 640, keyword exclusion lists 645 and/or third party APIs is illustrated. At step 680, a product entry point, such as for example a message from a safe agent script 620 of a publisher content 610, is received along with a campaign ID and publisher ID. At step 681, a determination is made if publisher ID and campaign ID are received and/or correct and if placement ID is found. At step 682, category IDs are determined or read. At step 683, API entry point, such as for example a message from a third party API, is received. The third party API message or call may include category IDs. Category IDs may be used to determine categories, specific URL exclusion lists 640, specific keyword exclusion lists 645 and/or specific third party APIs to be used to determine safeness of web pages 517. At step 684, filter models for categories may be retrieved. At step 685, if web page 517 is not cached, web page 517 may be spidered. At step 686, URL of the web page 517 may be filtered against third party APIs. At step 687, URL of web page 517 may be filtered against internal lists of URLs, such as for example URL exclusion lists 640. At step 688, internal content of web page 517 may be filtered against internal content filters, such as keyword exclusion lists 645. At step 689, content of web page 517 may be filtered against third party APIs. At step 690, a determination may be made if the process of determination of web page safeness is initiated via API mode, such as for example using an API call or function. At step 691, if API mode at step 690 is used a response with list of error codes for each passed category may be generated. At step 692, if API mode at step 690 is not used, a determination may be made if web page 517 is safe. At step 693, if web page 517 is determined to be safe at step 692, a determination is made if a campaign script is available or present. At step 694, if at step 693 a determination is made that campaign script is not available or if at step 692 a determination is made that page is not safe, a determination to setup a house ad script is made. At step 695, if at step 694 a determination is made not to setup a house ad script or if at step 681 one of publisher ID, campaign ID and/or placement ID is missing, a blank content is served. At step 696, if at step 694 a determination is made to setup a house ad script, house ad script is served. At step 697, if campaign script is determined to be available at step 693, campaign script is served.

At step 680, an embodiment of a product entry point to safeness determination process is illustrated. The product entry point may refer to an instance in which a message from a safe agent script 620 of a publisher content 610 is received along with a campaign ID and publisher ID. The publisher content 610 may be affiliated or associated with the server 110 on which AMD 635 is operating or with an enterprise which is a customer of the publisher owning or operating server 110. The message or the call received may include campaign ID and publisher ID. The message or the call received may also include URLs, keywords, portions of content or any other information of a particular web page 517 whose safeness for displaying particular publisher content 610 is to be determined.

At step 681, ADM 635 determines if publisher ID and campaign ID are received, valid and/or available. ADM 635 may also determine if placement ID for publisher content 610 is found or retrieved.

At step 682, ADM 635 may identify or read category IDs. The category IDs may identify categories which may be used for determination of safeness of web page 517. In some embodiments, category IDs identify categories which may include one or more URL exclusion lists 640, one or more keyword exclusion lists and/or one or more third party APIs. Categories may identify particular exclusion lists or APIs to be used for determining safeness of a particular publisher content 610 affiliated or associated with safe agent script 620 whose call is received at step 680.

At step 683, an embodiment of an API entry point is illustrated. The API entry point may refer to an instance in which a message from a third party publisher, such as a third party ad exchange website, is received. The API entry point may also refer to instances in which a message from a third party safe agent script 620 is received. The third party safe agent script 620 may be any safe agent script of a publisher content 610 that is owned, stored and/or provided by a third party company, enterprise or a third party ad exchange website. The third party publisher may send category IDs for identifying categories to be used for determining safeness of web page 517. The third party publisher content 610 for which safeness of web page 517 is to be determined may be associated with ad exchange website that is not provided or maintained by server 110. The API message or call received may include campaign ID and publisher ID. The API message or call received may also include URLs, keywords, portions of content or any other information of a particular web page 517 whose safeness for displaying the third party particular publisher content 610 is to be determined.

At step 684, filter model for categories are retrieved. In some embodiments, if a message or call is received using API entry point, as in step 683, filters are retrieved using category IDs received at step 683. In other embodiments, if a message or call is received using product entry point at step 680, filters are retrieved using category IDs identified at step 682. Filters may be retrieved by identifying URL exclusion lists 640, keyword exclusion lists 645 and/or third party APIs to be used for determining safeness of web page 517.

At step 685, if web page 517 is not cached, a web page 517 may be spidered. Indexing or spidering web page 517 may involve copying and/or caching contents of web page 517. Web page 517 may be parsed and stored so content keywords, phrases and/or URLs may be matched and compared against the entries of URL exclusion lists 640, keyword exclusion lists 645 and/or third party APIs.

At step 686, URLs of web page 517 may be filtered or matched against any number of third party APIs. In some embodiments, web page 517 URL may be matched against one or more entries or portions of content from APIs from a third party publisher, such as a third part ad exchange. In other embodiment, URLs of links or hyperlinks within web page 517 may be matched against content of the third party APIs. In further embodiments, any URL received at step 680 or 683 may be compared against any entry, portion of content, a portion of URL or a string of characters of any API from any third party publisher. Third party APIs may be identified by categories associated or identified by category IDs.

At step 687, URL of web page 517 may be filtered or matched against internal lists stored on server 110, such as URL exclusion lists 640 or keyword exclusion lists 645. In some embodiments, URL of web page 517 is matched against any entry of a URL exclusion list 640. In other embodiments, URL of web page 517 is matched against any entry of keyword exclusion list 645. URL exclusion list 640 or keyword exclusion list 645 may be identified by category IDs.

At step 688, content of spidered or indexed web page 517 is filtered or matched against internal content filters. ADM 635 may match or compare each individual word, keyword, string of characters, tag, script or any portion of web page 517 against internal content lists to determine safeness of web page 517. Internal content lists may include any exclusion list, such as URL exclusion list 640 or keyword exclusion list 645. In some embodiments, web page 517 content, such as keywords, strings of characters, meta tags and/or any portion of web page 517 content are matched against URL exclusion lists 640 and/or keyword exclusion lists 645. Content of spidered web page 517 may be compared and/or matched against each individual entry of URL exclusion lists 640 and keyword exclusion list 645 identified by category IDs received. Internal content filters may comprise functions or logic by ADM 635 for comparing and/or matching content of web page 517 against URL exclusion list 640 or keyword exclusion list 645.

At step, 689, content of spidered web page 517 is filtered or matched against third party APIs. ADM 635 may match or compare each individual word, keyword, string of characters, tag, script or any portion of web page 517 against any portion of one or more third party APIs to determine safeness of web page 517. The third party APIs used to determine safeness of web page 517 may be identified by category IDs. The third party APIs may include any information from the third party publisher or ad exchange used for determining safeness of the web pages 517 on which the third party publisher content 610 is displayed. In some embodiments, web page 517 content, such as keywords, strings of characters, meta tags and/or any portion of web page 517 content are matched against any portion of a third party API. Content of spidered web page 517 may be compared and/or matched against any third party API identified by category IDs received at step 683.

At step 690, ADM 635 determines if the process of determining safeness of web page 517 is initiated via API entry at step 683 or product entry at step 680. In some embodiments, ADM 635 determines that ADM 635 is called via API mode. In some embodiments, AMD 635 determines that ADM 635 is not called via API mode.

At step 691, if a determination at step 690 is made that the call was made via API mode, ADM 635 responds with list o error codes. The list of error codes may include error codes for each category tested, implemented or passed. In some embodiments, the list of error codes includes information identifying categories of third party APIs and exclusion lists 640 and 645 used for this particular API call.

At step 692, ADM 635 makes a determination if web page 517 is safe. ADM 635 may make same or similar determinations as in step 621 of FIG. 6B. At step 692, ADM 635 may make same or similar determinations as in step 674 of FIG. 6C or step 584 of FIG. 5K.

At step 693, ADM 635 determines if campaign script is present and/or available. The campaign script may include any information or instructions for displaying publisher content 610 or third party publisher content 610 within web page 517. In some embodiments, campaign script includes or is affiliated with a particular publisher content 610 that is safe to be displayed within web page 517. In some embodiments, ADM 635 determines if script and/or advertisement content for the campaign used by the publisher or the third party publisher is available or present. In other embodiments, ADM 635 determines or formulates a message with instructions to display the third party publisher content 610 within web page 517 because web page 517 is determined to be safe. In further embodiments, ADM 635 determines or formulates a message with instructions to go ahead and display the publisher content 610 of the publisher within web page 517 because web page 517 is determined to be safe.

At step 694, ADM 635 determines if house ad script is setup. House ad script may include any set of instructions of functions for displaying publisher content 610 different from the publisher content 610 determined not to be safe to display with web page 517 at step 692. House ad script may include any content, such as publisher content 610, to display instead of the publisher content 610 determined not to be safe to display with web page 517 at step 692. In some embodiments, ADM 635 determines if house ad script is setup responsive to determination at step 692 that page is not safe. In other embodiments, ADM 635 determines if house ad script is setup responsive to determination at step 693 that campaign script is not present or not available. Determination that house ad script is setup may include determining if a new publisher content 610 is available or present to be delivered to the third party publisher or the publisher to be displayed instead of the publisher content 610. Determination that house ad script is setup may include determining if instructions and/or new publisher content 610 can be sent to the third party publisher or the publisher to display the new publisher content 610 instead of the previous publisher content 610.

At step 695, ADM 635 serves blank content to be served instead of publisher content 610 or instead of the third party publisher content 610. ADM 635 may transmit to the third party publisher or the publisher any blank content or any instruction for displaying blank content. ADM 635 may instruct the third party safe agent 620 script to display blank content instead of the third party publisher content 610 in response to determining that house ad script is not setup or available. ADM 635 may server blank content to the third party publisher or the publisher instead responsive to determination that new publisher content 610 to be displayed instead of the original publisher content 610 is not available.

At step 696, house ad script is served. ADM 635 may serve house ad script along with the new publisher content 610 to the third party publisher, such as the third party advertisement exhange website. In some embodiments, ADM 635 serves or sends new publisher content 610 to be displayed instead of the publisher content 610 for which web page 517 is determined to be unsafe. ADM 635 may send instructions via house ad script to display publisher content 610 which is different from the original publisher content 610 for which web page 517 is determined to be unsafe.

At step 697, campaign script is served. ADM 635 may server campaign script along with the original publisher content 610 for which web page 517 is determined to be safe. ADM 635 may transmit updated publisher content 517 to the third party publisher or the publisher. In some embodiments, ADM 635 serves or sends an updated publisher content 610 to be displayed instead of the publisher content 610 for which web page 517 is determined to be safe. ADM 635 may send instructions via house ad script to display publisher content 610 present at the third party publisher or the publisher.

Referring now to FIG. 6F, an embodiment of a database for storing information pertaining to publisher contents 610 at augmentation server 110 is displayed. As with embodiment of a database in FIG. 6D, information may be organized in one or more tables, such as agencies table, campaign table, campaign placements table, publishers table, publisher placements table and others.

In further overview of FIG. 6F, tables may include any information or data regarding the processes described herein, including the agencies, campaigns, keywords, URLs, publisher contents 610, third party publisher contents 610, third party APIs, keyword exclusion lists 645 and URL exclusion lists 640 and more.

Agencies table may include agency identifiers or IDs, agency names and customer relationship management (CRM) identifiers and labels. CRMs may identify needs, preferences and/or behavior of customer. A campaign table may include a campaign ID, a campaign name, start date, end date, agency ID, territory ID, created by information and created date information. A campaign placements table may include campaign placement ID, campaign ID and creative script. A publisher placements table may include publisher placement ID, publisher ID, size ID, house ad script and category ID. A publishers table may include publisher ID, publisher name and agency ID.

Other tables, such as categories table may include category ID, description, created date information, created by information and archived information. VIA Campaigns table may comprise campaign ID and category ID. Group Mappings table may include category ID, group ID and type information. URL groups table may include URL group ID and URL ID information. URL group definition table may include URL group ID, description information, created date information and created by information. URLs table may include URL IDs and URLs. Keyword groups table may include keyword group IDs and keyword. Keywords table may include keyword IDs and keywords. Keyword group definition table may include keyword group ID, description information, created date information and created by information.

We claim:

1. A method for determining that content of a web page is content safe for delivering content from a publisher, the method comprising:
(a) identifying, by a script of a web page being loaded by a browser executing on a client, that content from a publisher is to be displayed with content of the web page;
(b) transmitting, by the script to a server, a request to check a safeness of the content of the web page prior to displaying the publisher's content; and
(c) receiving, by the script from the server responsive to the server determining the content of the web page is not safe for the publisher, a predetermined content not from the publisher to display on the web page.

2. The method of claim 1, further comprising displaying, by the browser, the predetermined content instead of the content from the publisher.

3. The method of claim 1, wherein step (a) further comprises identifying, by the script, a publisher identifier for the content.

4. The method of claim 1, wherein step (a) further comprises identifying, by the script, a campaign identifier of the publisher.

5. The method of claim 1, wherein step (b) further comprise transmitting, by the script, with the request one of a publisher identifier or a campaign identifier to the server.

6. The method of claim 1, wherein step (b) further comprise transmitting, by the script, with the request a uniform resource locator of the web page.

7. The method of claim 1, wherein step (c) further comprises receiving, by the script from the server, the predetermined content comprising blank content.

8. The method of claim 1, wherein step (c) further comprises receiving, by the script from the server, the predetermined content comprising a predetermined advertisement not from the publisher.

9. The method of claim 1, wherein step (c) further comprises modifying, by the script, the keyword to include a hyperlink identifying a uniform resource locator to the predetermined content.

10. The method of claim 1, further comprising executing, by the browser, the script upon loading of the web page by the browser.

11. The method of claim 1, further comprising receiving, by the browser, the content from the publisher together with the script while the browser loads the web page.

12. A method for determining that content of a web page is content safe for delivering content from a publisher, the method comprising:
(a) receiving, by a server from a browser of a client, a request to check a safeness of content of a web page being loaded by the browser, the content of the web page having a content of a publisher to be displayed;
(b) obtaining, by the server, for the publisher a list of exclusion uniform resource locators for which to exclude displaying the content of the publisher; and
(c) determining, by the server, whether a uniform resource locator of the web page matches an exclusion uniform resource locator in the list of exclusion uniform resources locators for the publisher.

13. The method of claim 12, wherein step (a) further comprises receiving, by the server, with the request a publisher identifier and a campaign identifier of the publisher.

14. The method of claim 12, wherein step (a) further comprises receiving, by the server, with the request the one or more resource locators of the web page.

15. The method of claim 12, wherein step (b) further comprises selecting, by the server, for the publisher the list of exclusion uniform resource locators based on a campaign identifier of the publisher.

16. The method of claim 12, wherein step (c) further comprises determining, by the server, that the uniform resource locator of the web page matches the exclusion uniform resource locator in the list of exclusion uniform resources locators.

17. The method of claim 12, wherein step (c) further comprises determining, by the server, that a second uniform resource locator linked via the web page matches the exclusion uniform resource locator in the list of exclusion uniform resources locators.

18. The method of claim 16, further comprises transmitting, by the server to the browser, a predetermined content not from the publisher to be displayed on the web page responsive to determining that the uniform resource locator of the web page matches a in the list of exclusion uniform resources locators for the publisher.

19. The method of claim 10, further comprising transmitting, by the server to the browser, content of the publisher to augment to display on the web page responsive to determining that the uniform resource locator of the web page does not match any entries in the list of exclusion uniform resources locators for the publisher.

20. The method of claim 10, further comprising obtaining, by the server, a list of exclusion keywords identifying portions of the uniform resource locator of the web page for which to exclude displaying the content of the publisher.

21. The method of claim 18, further comprising determining, by the server, whether a portion of the uniform resource locator of the web page matches an exclusion keyword in the list of exclusion keywords.

22. The method of claim 19, further comprising transmitting, by the server, a predetermined content not from the publisher to display on the web page in response to determining that the portion of the uniform resource locator matches the exclusion keyword in the list of exclusion keywords.

23. A method for determining that content of a web page on which additional content is to be displayed is content safe for delivering the additional content from an advertisement network, the method comprising:
(a) identifying, by a script of a browser executing on a client and upon loading a web page, that the web page is to be augmented with content from an advertisement network;
(b) transmitting, by the script to a server, a request to check a safeness of content of the web page prior to augmenting the web page with the content from the advertisement network; and
(c) receiving, by the script from the server responsive to the server determining the content of the web page is not safe, predetermined content not from the advertisement network to be displayed instead of the content from the advertisement network.
